(19) United States
(12) Patent Application Publication
(10) Pub. No.: US 2020/0269194 A1
(43) Pub. Date: Aug. 27, 2020

(54) POROUS MEMBRANE CONTAINING METAL-ORGANIC FRAMEWORKS

(71) Applicants: KING FAHD UNIVERSITY OF PETROLEUM AND MINERALS, Dhahran (SA); KING ABDULAZIZ CITY FOR SCIENCE AND TECHNOLOGY, Riyadh (SA)

(72) Inventors: Bassem A. Al-Maythalony, Dhahran (SA); Akram S. Ghanem, Dhahran (SA); Mohamed Ba-Shammakh, Dhahran (SA); Muhammad Usman, Dhahran (SA)

(73) Assignees: KING FAHD UNIVERSITY OF PETROLEUM AND MINERALS, Dhahran (SA); KING ABDULAZIZ CITY FOR SCIENCE AND TECHNOLOGY, Riyadh (SA)

(21) Appl. No.: 16/285,724

(22) Filed: Feb. 26, 2019

(51) Int. Cl. B01D 69/14; B01D 53/22; B01D 71/64; B01D 67/00; B01D 69/02

(52) U.S. Cl. CPC B01D 69/141; B01D 53/228; B01D 71/64; B01D 2325/026; B01D 67/0016; B01D 69/02; B01D 67/0013

(57) ABSTRACT

A porous membrane which has a sponge-like morphology. The porous membrane contains imidazole- and benzimidazole-based metal-organic framework fillers embedded in a polymer matrix. Methods of fabricating the porous membrane via steps including solvent casting and coagulating are described. Methods of separating gases using the porous membrane are also provided.

### BACKGROUND OF THE INVENTION

### Technical Field

The present invention relates to a porous membrane with a sponge-like morphology, which has imidazole- and benzimidazole-based metal-organic framework fillers present in a polymer matrix. Methods of producing the membrane and separating a mixture of gases using the membrane are also disclosed.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Zeolitic imidazolate frameworks (ZIFs) are a class of metal-organic frameworks that are topologically isomorphic with zeolites. Due to their robust porosity, resistance to thermal changes, and chemical stability, ZIF's may be good candidates for applications such as carbon capture, separation of hydrogen and carbon dioxide, catalysis, sensing, and drug delivery.

Polyimide (PI) is a polymer based on imide monomers, which may be prepared via reactions between a dianhydride and a diamine or between a dianhydride and a diisocyanate. Thermosetting polyimides are known for thermal stability, good chemical resistance, and excellent mechanical properties.

In view of the forgoing, one objective of the present disclosure is to provide a spongy membrane containing an imidazole- and benzimidazole-based metal-organic framework filler embedded in a polymer matrix. A further objective of the present disclosure is to provide a method of fabricating the membrane and a method of utilizing the membrane in gas separation processes.

### BRIEF SUMMARY OF THE INVENTION

According to a first aspect, the present disclosure relates to a membrane involving a polymer matrix, and a metal-organic framework filler containing a ligand coordinated to a metal ion, wherein the ligand comprises an imidazole of formula (I) and a benzimidazole of formula (II):

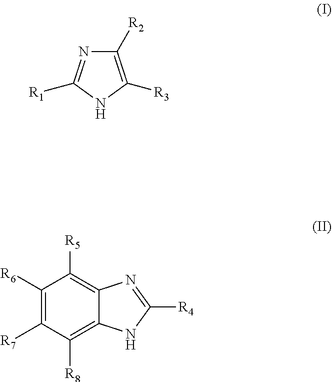

wherein R₁, R₂, R₃, R₄, R₅, R₆, R₇, and R₈ are each independently selected from the group consisting of a hydrogen, an optionally substituted alkyl, an optionally substituted cycloalkyl, an optionally substituted alkoxy, a hydroxyl, a halogen, a nitro, and a cyano, the metal ion is an ion of at least one metal selected from the group consisting of a transition metal, a post-transition metal, and an alkaline earth metal, the metal-organic framework filler is embedded in the polymer matrix at an amount of 1 wt %-50 wt % relative to a total weight of the membrane, and the membrane has pores and a spongy morphology.

In one embodiment, the pores have an average diameter in a range of 0.5-10 μm.

In one embodiment, the pores are monolithic and substantially parallel to each other.

In one embodiment, the polymer matrix comprises at least one selected from the group consisting of a polyimide, a polyamide, a polyamide-imide, a polyetherimide, and a polyether ether ketone.

In one embodiment, the polymer matrix comprises the polyimide.

In one embodiment, the imidazole of formula (I) is 2-methylimidazole.

In one embodiment, the benzimidazole of formula (II) is 5-methylbenzimidazole.

In one embodiment, a molar ratio between the imidazole of formula (I) to the benzimidazole of formula (II) ranges from 1:1 to 1:4.

In one embodiment, the metal ion is an ion of at least one metal selected from the group consisting of Zn, Cu, Fe, Ni, Co, Mn, Cr, Cd, Mg, Ca, and Zr.

In one embodiment, the metal-organic framework filler comprises ZIF-302.

In one embodiment, the membrane comprises 1-10 wt % of the metal-organic framework filler relative to a total weight of the membrane.

In one embodiment, the metal-organic framework filler is in the form of block-shaped particles with an average particle size of 0.5-5 μm.

In one embodiment, the metal-organic framework filler has a BET surface area in a range of 350-450 m²/g.

In one embodiment, the membrane has an ideal selectivity of hydrogen over a gas selected from the group consisting of oxygen, nitrogen, carbon dioxide and methane in a range of 2-70, and an ideal selectivity of carbon dioxide over a gas selected from the group consisting of nitrogen and methane in a range of 15-35.

According to a second aspect, the present disclosure relates to a method of producing the membrane of the first aspect in which the polymer matrix comprises the polyimide. The method involves: (i) suspending the metal-organic framework filler in a first solvent to form a suspension, (ii) dissolving the polyimide in a second solvent to form a solution, (iii) mixing the suspension with the solution to form a mixture, (iv) casting the mixture to form a membrane blend, (v) coagulating the membrane blend at a temperature of 20-90° C. for 18-36 hours to form a coagulated membrane, and (vi) drying the coagulated membrane at a temperature of 150-250° C. for 6-24 hours thereby forming the membrane. A weight ratio of the metal-organic framework filler to the polyimide is in a range of 1:99 to 1:1.

In one embodiment, the first solvent is dimethylacetamide.

In one embodiment, the second solvent comprises dimethylacetamide and dimethylformamide.

In one embodiment, the suspension is mixed with the solution for a period of 6-24 hours at 30-60° C. under reduced pressure.

According to a third aspect, the present disclosure relates to a method of recovering a first gas from a gas mixture comprising the first gas and a second gas. The method involves (i) delivering the gas mixture into a feed side of a chamber comprising the membrane of the first aspect that divides the chamber into the feed side and a permeate side, such that at least a portion of the first gas permeates the membrane, and (ii) recovering from the permeate side a stream enriched in the first gas compared to the gas mixture.

In one embodiment, the first gas is hydrogen, carbon dioxide, or both, and the second gas is at least one selected from the group consisting of oxygen, nitrogen, and methane.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a scanning electron microscope (SEM) image of a cross-section of a dense polyimide (d-PI) membrane.

FIG. 2 is a SEM image of a cross-section of a pure, spongy polyimide (s-PI) membrane.

FIG. 3 is an overlay of a powder X-ray diffraction (PXRD) pattern of ZIF-302 and a simulated PXRD pattern of ZIF-302.

FIG. 4 is a proton nuclear magnetic resonance (¹H NMR) spectrum of a digested sample of ZIF-302.

FIG. 5A is a carbon-13 nuclear magnetic resonance (¹³C NMR) spectrum of a digested sample of ZIF-302.

FIG. 5B is an expanded view of the ¹³C NMR spectrum in FIG. 5A from 112 to 142 ppm

FIG. 6 is a thermogravimetric curve of ZIF-302.

FIG. 7A is a SEM image of ZIF-302.

FIG. 7B is another SEM image of ZIF-302.

FIG. 8 is a graph illustrating N₂ adsorption/desorption isotherms of ZIF-302 at 77 K.

FIG. 9 is an overlay of CO₂ adsorption/desorption isotherms of ZIF-302 at 273 K, 298 K, and 313 K.

FIG. 10 is a graph illustrating the relationship between the isosteric heat of adsorption (Qₛₜ) of ZIF-302 and CO₂ uptake.

FIG. 11 is an overlay of CO₂, CH₄, and N₂ adsorption/desorption isotherms of ZIF-302 at 298 K.

FIG. 12 is a SEM image of a cross-section of a mixed matrix membrane having 5 wt % of ZIF-302 embedded in dense polyimide (d-PI).

FIG. 13 is a SEM image of a cross-section of a mixed matrix membrane having 5 wt % of ZIF-302 embedded in spongy polyimide (s-PI).

FIG. 14A is a SEM image of a surface of the mixed matrix membrane having 5 wt % of ZIF-302 embedded in dense polyimide (d-PI).

FIG. 14B is an energy dispersive X-ray (EDX) analysis of the surface of the mixed matrix membrane of FIG. 14A.

FIG. 15A is a SEM image of a cross-section of the mixed matrix membrane having 5 wt % of ZIF-302 embedded in dense polyimide (d-PI).

FIG. 15B is an EDX analysis of the cross-section of the mixed matrix membrane of FIG. 15A.

FIG. 16A is a SEM image of a surface of the mixed matrix membrane having 5 wt % of ZIF-302 embedded in spongy polyimide (s-PI).

FIG. 16B is an EDX analysis of the surface of the mixed matrix membrane of FIG. 16A.

FIG. 17A is a SEM image of a cross-section of the mixed matrix membrane having 5 wt % of ZIF-302 embedded in spongy polyimide (s-PI).

FIG. 17B is an EDX analysis of the cross-section of the mixed matrix membrane of FIG. 17A.

FIG. 18 is an overlay of a simulated PXRD pattern of the single crystal structure of ZIF-302, and PXRD patterns of ZIF-302, the dense polyimide (d-PI) membrane, and the mixed matrix membrane having 5 wt % of ZIF-302 embedded in dense polyimide (d-PI), respectively.

FIG. 19 is an overlay of a simulated PXRD pattern of the single crystal structure of ZIF-302, and PXRD patterns of ZIF-302, the spongy polyimide (s-PI) membrane, and the mixed matrix membrane having 5 wt % of ZIF-302 embedded in spongy polyimide (s-PI), respectively.

FIG. 20 is an overlay of thermogravimetric curves of ZIF-302, the dense polyimide (d-PI) membrane, and the mixed matrix membrane having 5 wt % of ZIF-302 embedded in dense polyimide (d-PI).

FIG. 21 is an overlay of thermogravimetric curves of ZIF-302, the spongy polyimide (s-PI) membrane, and the mixed matrix membrane having 5 wt % of ZIF-302 embedded in spongy polyimide (s-PI).

FIG. 22 is a schematic illustration of a constant-volume/variable-pressure (CV/VP) gas permeation setup.

FIG. 23 is an overlay of single gases (H₂, O₂, CO₂, N₂, CH₄) permeation against time for the dense polyimide (d-PI) membrane at 35° C. and 1520 Torr.

FIG. 24 is an overlay of single gases (H₂, O₂, CO₂, N₂) permeation against time for the spongy polyimide (s-PI) membrane at 35° C. and 1520 Torr.

FIG. 25 is an overlay of single gases (H₂, O₂, CO₂, N₂) permeation against time for the mixed matrix membrane having 5 wt of ZIF-302 embedded in dense polyimide (d-PI).

FIG. 26 is an overlay of single gases (H₂, O₂, CO₂, N₂, CH₄) permeation against time for the mixed matrix membrane having 5 wt % of ZIF-302 embedded in spongy polyimide (s-PI).

FIG. 27 is a graph illustrating the general expression of time lag and steady state criteria found through CV/VP measurements.

FIG. 28 is a graph comparing gas permeabilities of the dense polyimide (d-PI) membrane, the spongy polyimide (s-PI) membrane, and the mixed matrix membranes each having 5 wt %/o of ZIF-302 embedded in dense polyimide (d-PI), and spongy polyimide (s-PI), respectively.

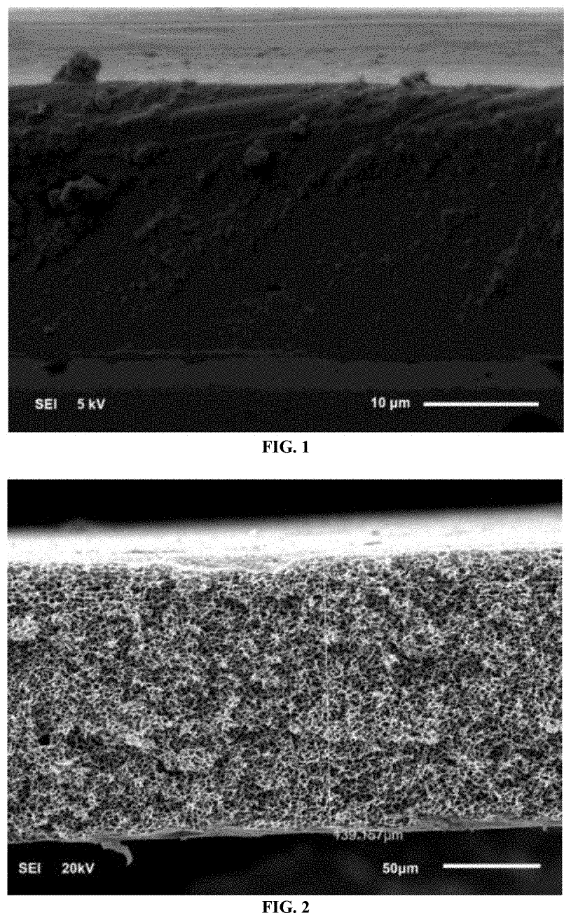

### DETAILED DESCRIPTION OF THE EMBODIMENTS

Embodiments of the present disclosure will now be described more fully hereinafter with reference to the accompanying drawings, in which some, but not all embodiments of the disclosure are shown.

As used herein, the words “a” and “an” and the like carry the meaning of “one or more”. Within the description of this disclosure, where a numerical limit or range is stated, the endpoints are included unless stated otherwise. Also, all values and subranges within a numerical limit or range are specifically included as if explicitly written out.

As used herein, the term “alkyl” unless otherwise specified refers to both branched and straight chain saturated aliphatic primary, secondary, and/or tertiary hydrocarbon fragments of typically C₁ to C₂₀. Non-limiting examples of such hydrocarbon fragments include methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, 2-propylheptyl, tetradecyl, pentadecyl, hexadecyl, heptadecyl, octadecyl, nonadecyl, and eicosyl.

The term “cycloalkyl” refers to cyclized alkyl groups. Exemplary cycloalkyl groups include, but are not limited to, cyclopropyl, cyclobutyl, cyclopentyl, cyclohexyl, norbornyl, and adamantyl. Branched cycloalkyl groups such as exemplary 1-methylcyclopropyl and 2-methylcyclopropyl groups are included in the definition of cycloalkyl as used in the present disclosure.

The term “alkoxy” refers to a straight or branched chain alkoxy including, but not limited to, methoxy, ethoxy, propoxy, isopropoxy, butoxy, isobutoxy, secondary butoxy, tertiary butoxy, pentoxy, isopentoxy, hexyloxy, heptyloxy, octyloxy, nonyloxy, and decyloxy.

The term “halogen”, as used herein, means fluoro, chloro, bromo and iodo.

As used herein, the term “substituted” refers to at least one hydrogen atom is replaced with a non-hydrogen group, provided that normal valencies are maintained and that the substitution results in a stable compound. When a R group (denoted as R₁, R₂, and so forth) is noted as “optionally substituted”, the substituents are selected from the exemplary group including, but not limited to, halogen (e.g., chlorine, bromine, fluorine or iodine), alkoxy (i.e., straight chain alkoxy having 1 to 3 carbon atoms, and includes, for example, methoxy, ethoxy, and propoxy), hydroxy, amino, alkylamino, thiol, alkylthio, sulfonamido (e.g., —SO₂NH₂), substituted sulfonamide (e.g., —SO₂NHalkyl or cases where there are two alkyl substituents on one nitrogen), nitro, cyano, carboxy, carbamyl (e.g., —CONH₂), substituted carbamyl (e.g., —CONHalkyl or cases where there are two alkyl substituents on one nitrogen), and mixtures thereof. The substituents may be either unprotected, or protected as necessary, as known to those skilled in the art, for example, as taught in Greene et al., “Protective Groups in Organic Synthesis”, John Wiley and Sons, Second Edition, 1991, hereby incorporated by reference in its entirety).

According to a first aspect, the present disclosure relates to a membrane involving a polymer matrix, and a metal-organic framework filler containing a ligand coordinated to a metal ion. The metal-organic framework filler may present at an amount of 0.1 wt %-50 wt %, 0.5 wt %-40 wt %, 1 wt %-30 wt %, 2 wt %-20 wt %, 3 wt %-15 wt %, 4 wt %-10 wt %, or about 5 wt % relative to a total weight of the membrane.

The membrane may be a thin film membrane, a flat sheet membrane, a spiral membrane, a tubular membrane, or a hollow fiber membrane. The membrane may be in the form of various shapes, for example, flat (e.g., for a disc-shaped membrane), bent, curved (e.g., a cylinder shaped membrane), and rippled. In one embodiment, the membrane is a thin film membrane and has a thickness of 10-2,000 μm, 25-1,500 μm, 50-1,000 μm, 100-800 μm, 200-600 μm, 250-500 μm, or about 300 μm. In some embodiments where the membrane is disc-shaped, a diameter of the membrane may be 10-100 mm, 11-80 mm, or 12-50 mm. In some embodiments, the membrane is in a form of a rectangular sheet having a width of 2-110 cm, 10-70 cm, or 20-60 cm. A length of the rectangular sheet may range from 10 cm to 122 m, 100 cm to 50 m, 1 m to 20 m, or 5 m to 10 m.

Unlike a spongy membrane, a dense membrane may be essentially free of macrovoids including pores. When compared to dense membranes, a porous membrane having a sponge-like structural feature may be advantageous as it allows for high flux permeation and is capable of performing multi-stage separation processes across single membrane.

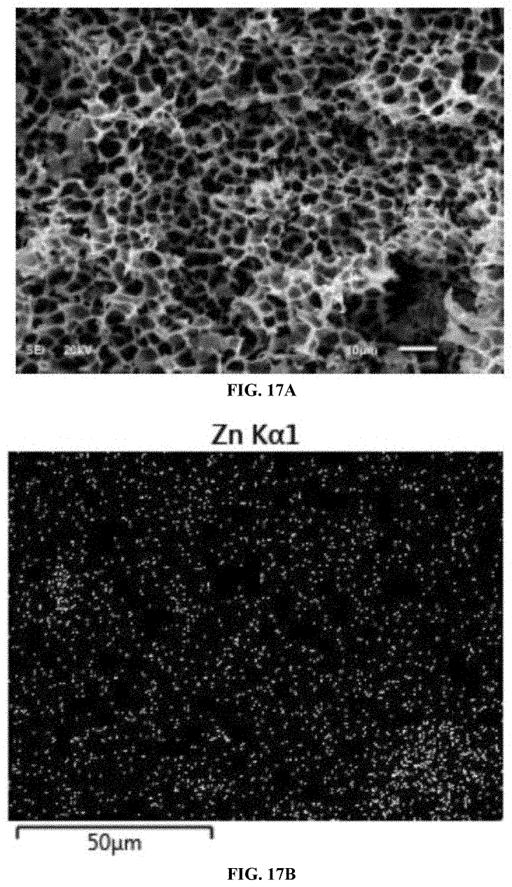

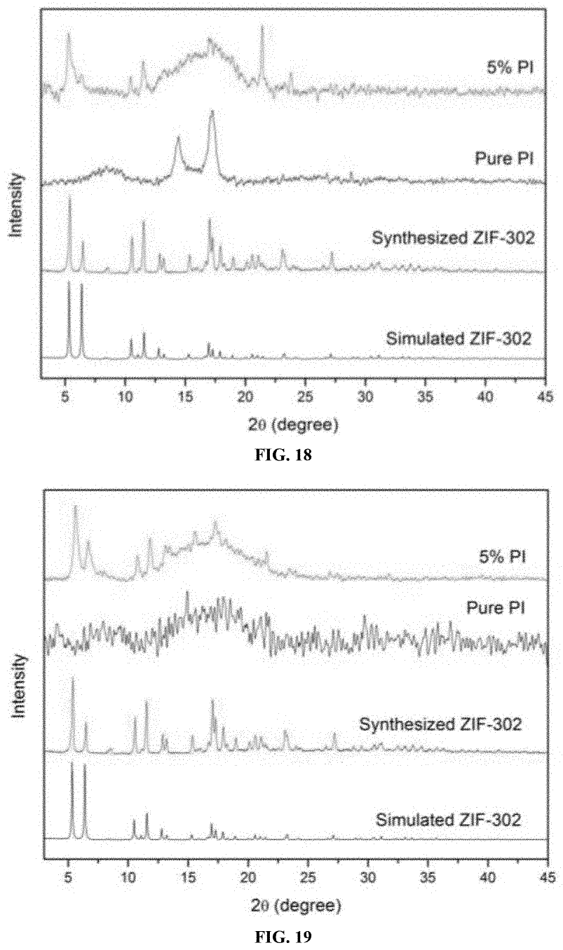

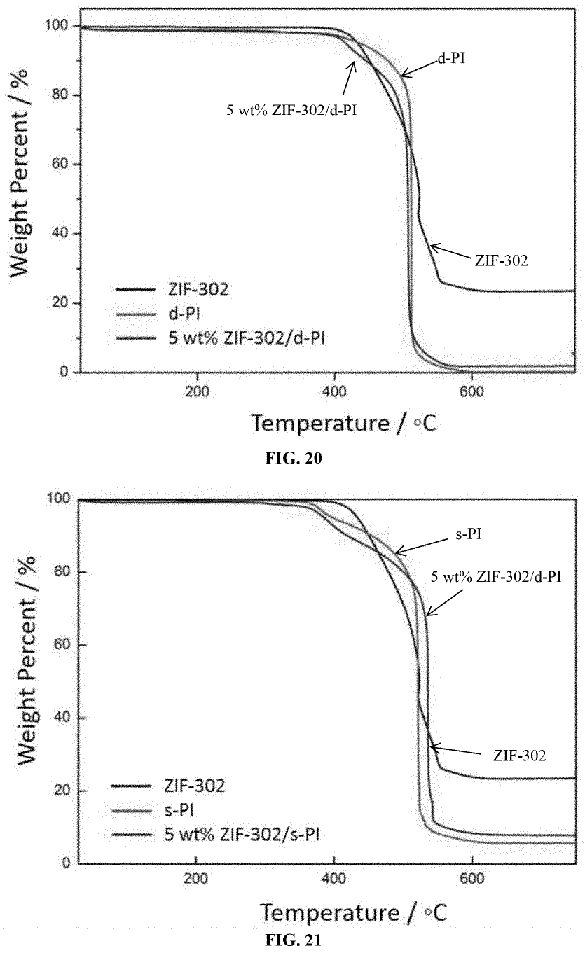

The membrane disclosed herein may have a porous morphology. In one or more embodiments, a cross-section of the membrane resembles a sponge (see for example FIGS. 13 and 17A). In a preferred embodiment, the membrane has unconnected pores each representing an isolated cavity having an unbroken pore wall. At least 50% of a total number of pores present in the membrane are unconnected, preferably at least 60%, preferably at least 70%, preferably at least 80%, preferably at least 90%, preferably at least 95% of the total number of pores present in the membrane are unconnected. The pores may be straight or substantially straight. In some embodiments, the pores may extend through the membrane without intersecting one another. In certain embodiments, pores present in the membrane are separated from each other throughout their respective length. In a preferred embodiment, the pores are monolithic and parallel or substantially parallel to each other. Alternatively, the membrane may contain pores which are part of a network of pores (i.e., a plurality of interconnected pores). In another embodiment, pores in the membrane are randomly oriented and may intersect. Alternatively, the membrane disclosed herein may be dense (e.g. nonporous).

Preferably, the membrane is a self-consistent spongy membrane. As used herein, “a self-consistent spongy membrane” refers to a membrane having pores uniformly arranged in the membrane substrate, i.e. a distance between a pore and all its neighbors is the same or substantially the same. The distance can be said to be substantially the same when the shortest distance is at least 80%, at least 85%, at least 90%, or at least 95% of the average distance and the longest distance is not more than 120%, not more than 110%, or not more than 105% of the average distance. The distance is measured from a center of a pore to a center of a neighboring pore and may be in a range of 1 nm to 1 μm, 10-800 nm, 50-600 nm, 100-400 nm, or 200-300 nm. Energy-dispersive X-ray spectroscopy, X-ray microanalysis, elemental mapping, transmission electron microscopy, scanning electron microscopy, and scanning transmission electron microscopy may be useful techniques for observing the arrangement of the pore in the membrane. Alternatively, the pores are randomly arranged in the membrane, i.e. distances between a pore and its neighboring pores are different.

The cross-section of pores of the membrane may have a regular shape, for example, a shape of a circle, an oval, or a polygon (e.g., triangle, rectangle, hexagon, rhombus, trapezium, parallelogram, pentagon, heptagon, octagon, nonagon, decagon, undecagon, and dodecagon). The polygon may be regular (i.e., all sides equal in length and all equal internal angles), convex (i.e., no internal angle is more than 180), or concave. In some embodiments, the cross-section of the pores may have an irregular shape in which each side has a different length and/or each side has a different curvature. For example, for pores with an irregular shaped cross-section having a first side, a second side, and a third side, the first and the second sides is a straight line, and the third is a curve. Further, the length of the first side is 1-50%, 5-40%, or 10-30% longer than a length of the second side.

The membrane may be macroporous, mesoporous, or microporous. The term “microporous” means the pores of the membrane have pores with an average diameter of less than 2 nm. The term “mesoporous” means the pores of the membrane have an average diameter of 2-50 nm. The term “macroporous” means the pores of the membrane have an average diameter larger than 50 nm. In one embodiment, the membrane is macroporous, and has pores with an average diameter in a range of 0.5-10 μm, 1-8 μm, 1.5-6 μm, 2-5 μm, or 3-4 μm. In another embodiment, the membrane has pores with an average diameter in a range of 1-100 nm, 2-75 nm, 3-50 nm, or 4-25 nm. A porosity of the membrane may be at least 10 vol %, at least 20 vol %, at least 30 vol %, at least 40 vol %, or at least 50 vol %, and up to 99.9 vol %, up to 99 vol %, up to 90 vol %, up to 85 vol %, up to 80 vol %, or preferably up to 75 vol %, based on a total volume of the membrane. In one embodiment, the porosity is calculated by taking a photograph of a cross section of the membrane, measuring a total void area using the photograph, and calculating the porosity as a ratio of void area with respect to an entire cross sectional area of the membrane. In this embodiment, the “areal” and “volumetric” porosities are equal for a porous media with a random structure. Alternatively, the porosity may be measured and/or calculated using N₂ adsorption/desorption isotherms (e.g., using Barret-Joyner-Halenda (BET) or non-local density functional theory), permporometry methods, industrial computed tomography scanning, and/or imbibition methods.

The Brunauer-Emmet-Teller (BET) theory (S. Brunauer, P. H. Emmett, E. Teller, J. Am. Chem. Soc. 1938, 60, 309-319, incorporated herein by reference) aims to explain the physical adsorption of gas molecules on a solid surface and serves as the basis for an important analysis technique for the measurement of a specific surface area of a material. Surface area is a property of solids which is the total surface area of a material per unit of mass, solid or bulk volume, or cross sectional area. In most embodiments, BET surface area is measured by gas adsorption analysis, preferably N₂ adsorption analysis. The membrane disclosed herein may have a BET surface area of 50-2,000 m²/g, 100-1,500 m²/g, 200-1,200 m²/g, 250-1,000 m²/g, 300-900 m²/g, 400-800 m²/g, or 500-700 m²/g.

The polymer matrix may be a continuous polymer matrix. A material with a high glass transition temperature (T_{g}), high melting point, and high crystallinity is preferred for most gas separations. Glassy polymers (i.e., polymers below their T_{g}) have stiffer polymer backbones and therefore let smaller molecules, such as hydrogen and helium, permeate the membrane more quickly and larger molecules, such as hydrocarbons, permeate the membrane more slowly. Preferably, the polymer is a rigid, glassy polymer. The polymer may have a weight average molecular weight (M_{w}) of 1×10⁴ to 2×10⁷ g/mol, 5×10⁴ to 1.5×10⁷ g/mol, or 1×10⁵ to 1×10⁷ g/mol. The polymer may have a polydispersity index (a measure of the width of molecular weight distribution) of 1 to 100, preferably 1 to 60, or 1 to 30.

Exemplary polymers that may be used as the polymer matrix include, without limitation, polyolefins, fluoropolymers (e.g., polyvinylidene fluoride (PVDF), polytetrafluoroethylene (PTFE)), polystyrene (e.g., isotactic polystyrene and syndiotactic polystyrene), thermoplastic elastomers (TPE), silicones (e.g., polydimethylsiloxane (PDMS) and polymethylphenylsilicone (PMPS)), polyacetylenes (e.g., polytrimethylsilylpropyne); polysulfonamides (e.g., poly[1-[4-(3-carboxy-hydroxyphenylazo)benzenesulfonamido]-1,2-ethanediyl]); polyethersulfones (PESs); sulfonated PESs; polyacetals; polyethers; polyetherimides such as Ultem (or Ultem 1000) sold under the trademark Ultem®, manufactured by Sabic Innovative Plastics: polyethylenimine; polystyrenes, including styrene-containing copolymers such as acrylonitrilestyrene copolymers, styrene-butadiene copolymers and styrene-vinylbenzylhalide copolymers; polycarbonates; cellulosic polymers such as cellulose acetate, cellulose triacetate, cellulose acetate-butyrate, cellulose propionate, ethyl cellulose, methyl cellulose, and nitrocellulose; polyamides (e.g., Nylon 6, polyphthalamide, aromatic polyamides, and aliphatic polyamides); polyimides such as Kapton (poly (4,4′-oxydiphenylene-pyromellitimide)) sold under the trademark Kapton® by DuPont, Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT® respectively from HP Polymers GmbH; polyamide imides; polyketones; polyether ketones (e.g., polyether ether ketone, sulfonated polyether ether ketone); polyarylene oxide such as polyphenylene oxide, polyxylene oxide, sulfonated polyxylene oxide and brominated polyxylene oxide; polyesteramidediisocyanate; polyurethanes; polyurea; polyazomethines; polyesters (including polyarylates such as polyethylene terephthalate, polyphenylene terephthalate; polyalkyl methacrylate; polyacrylate; polysulfides; polyethylene; polypropylene; polybutene-1; poly(4-methyl pentene-1); polyvinyls, e.g., polyvinyl chloride, polyvinyl fluoride, polyvinylidene chloride, polyvinylidene fluoride, polyvinyl alcohol, polyvinyl ester (e.g., polyvinyl acetate and polyvinyl propionate), polyvinyl pyridine, polyvinyl pyrrolidone, polyvinyl ether, polyvinyl ketone, polyvinyl aldehyde (e.g., polyvinyl formal and polyvinyl butyral), polyvinyl amide, polyvinyl amine, polyvinyl urethane, polyvinyl urea, polyvinyl phosphate, and polyvinyl sulfate; polyallyls; polybenzimidazoles; polyhydrazides; polyoxadiazoles; polytriazoles; polybenzimidazole; polycarbodiimides; polyphosphazines; microporous polymers; polycarbonates; polybenzoxazoles; and copolymers, including block copolymers (e.g., polyether block amide, polyether esters, and polyetherimide-siloxane polymers) or containing repeating units from the above such as copolymers of acrylonitrile-vinyl bromide-sodium salt of para-sulfophenylmethallyl ethers; and grafts and blends containing any of the foregoing.

In one embodiment, the polymer matrix comprises at least one polymer selected from the group consisting of a polyimide, a polyamide, a polyamide-imide, a polyetherimide, and a polyether ether ketone. In preferred embodiments, the polymer matrix comprises or consists of the polyimide. In some embodiments, polyimide is the only type of polymer used to construct the polymer matrix, that is, the polymer matrix is free of non-polyimide polymers (e.g., polyolefins) as either homopolymers or co-polymers. In at least one embodiment, the polymer matrix used herein is devoid of polysulfones (e.g. poly(1,4-phenylene ether-ether-sulfone), poly(1-hexadecene-sulfone), poly(1-tetradecene-sulfone), poly(oxy-1,4-phenylenesulfonyl-1,4-phenylene), poly(oxy-1,4-phenylenesulfonyl-1,4-phenylene), poly(oxy-1,4-phenylenesulfonyl-1,4-phenylene), poly(oxy-1,4-phenylenesulfonyl-1,4-phenylene), polyphenylsulfone, and Ultrason S 6010, BASF).

In the context of the present disclosure, polyimide is abbreviated as “PI”. Exemplary polyimides include, but are not limited to, Kapton®, Matrimid®, P84′, poly(3,3′,4,4′-benzophenone tetracarboxylic dianhydride-pyromellitic dianhydride-3,3′,5,5′-tetramethyl-4,4′-methylene dianiline) (or poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (or poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (or poly(DSDA-TMMDA)), poly(3,3′,4,4′-benzophenone tetracarboxylic dianhydride-3,3′,5,5′-tetramethyl-4,4′-methylene dianiline) (or poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (or poly(DSDA-PMDA-TMMDA)), and poly[2,2′-bis-(3,4-dicarboxyphenyl) hexafluoropropane dianhydride-2,2-bis(3-amino-4-hydroxyphenyl)-hexafluoropropane] (or poly(6FDA-APAF)), poly[3,3′,4,4′-benzophenonetetracarboxylic dianhydride-2,2-bis(3-amino-4-hydroxyphenyl)-hexafluoropropane] (or poly(BTDA-APAF)), poly(3,3′,4,4′-benzophenonetetracarboxylic dianhydride-3,3′-dihydroxy-4,4′-diamino-biphenyl) (or poly(BTDA-HAB)), poly[4,4′-oxydiphthalic anhydride-2,2-bis(3-amino-4-hydroxyphenyl)-hexafluoropropane] (or poly(ODPA-APAF)), poly[3,3′,4,4′-diphenylsulfone tetracarboxylic dianhydride-2,2-bis(3-amino-4-hydroxyphenyl)-hexafluoropropane] (or poly(DSDA-APAF)), poly(3,3′,4,4′-diphenylsulfone tetracarboxylic dianhydride-3,3′-dihydroxy-4,4′-diamino-biphenyl) (or poly(DSDA-HAB)), poly[2,2′-bis-(3,4-dicarboxyphenyl) hexafluoropropane dianhydride-3,3′,4,4′-benzophenonetetracarboxylic dianhydride-2,2-bis(3-amino-4-hydroxyphenyl)-hexafluoropropane] (or poly(6FDA-BTDA-APAF)), poly[4,4′-oxydiphthalic anhydride-2,2-bis(3-amino-4-hydroxyphenyl)-hexafluoropropane-3,3′-dihydroxy-4,4′-diamino-biphenyl] (or poly(ODPA-APAF-HAB)), poly[3,3′,4,4′-benzophenonetetracarboxylic dianhydride-2,2-bis(3-amino-4-hydroxyphenyl)-hexafluoropropane-3,3′-dihydroxy-4,4′-diamino-biphenyl] (or poly(BTDA-APAF-HAB)), poly[2,2′-bis-(3,4-dicarboxyphenyl) hexafluoropropane dianhydride-3,3′-dihydroxy-4,4′-diamino-biphenyl] (or poly(6FDA-HAB)), and poly(4,4′-bisphenol A dianhydride-3.3′,4,4′-benzophenonetetracarboxylic dianhydride-2,2-bis(3-amino-4-hydroxyphenyl)-hexafluoropropane) (or poly(BPADA-BTDA-APAF)).

In one or more embodiments, the ligand comprises an imidazole of formula (I) and a benzimidazole of formula (II):

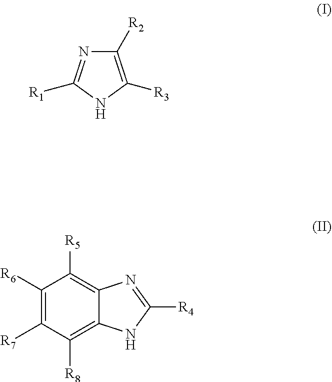

wherein R₁, R₂, R₃, R₄, R₅, R₆, R₇, and R₈ are each independently selected from the group consisting of a hydrogen, an optionally substituted alkyl, an optionally substituted cycloalkyl, an optionally substituted alkoxy, a hydroxyl, a halogen, a nitro, and a cyano. Preferably, R₁, R₂, R₃, R₄, R₅, R₆, R₇, and R₈ are each independently a hydrogen, an optionally substituted C₁-C₃ alkyl group, or an optionally substituted C₃-C₆ cycloalkyl group. More preferably, R₁, R₂, R₃, R₄, R₅, R₆, R₇, and R₈ are each independently a hydrogen or a methyl.

Exemplary imidazole-based ligands that may be applicable to the current disclosure include, but are not limited to, imidazole, 2-methylimidazole, 4-methylimidazole, 2-ethylimidazole, 2-isopropylimidazole, 4-tert-butyl-1H-imidazole, 2-ethyl-4-methylimidazole, 2-bromo-1H-imidazole, 4-bromo-1H-imidazole, 2-chloro-1H-imidazole, 2-iodoimidazole, 2-nitroimidazole, 4-nitroimidazole, (1H-imidazol-2-yl)methanol, 4-(hydroxymethyl)imidazole, 2-aminoimidazole, 4-(trifluoromethyl)-1H-imidazole, 4-cyanoimidazole, 3H-imidazole-4-carboxylic acid, 4-imidazolecarboxylic acid, imidazole-2-carboxylic acid, 2-hydroxy-1H-imidazole-4-carboxylic acid, 4,5-imidazoledicarboxylic acid, 5-iodo-2-methyl-1H-imidazole, 2-methyl-4-nitroimidazole, 2-(aminomethyl)imidazole, 4,5-dicyanoimidazole, 4-imidazoleacetic acid, 4-methyl-5-imidazolemethanol, 1-(4-methyl-1H-imidazol-5-yl)methanamine, 4-imidazoleacrylic acid, 5-bromo-2-propyl-1H-imidazole, ethyl-(1H-imidazol-2-ylmethyl)-amine, and 2-butyl-5-hydroxymethylimidazole. In preferred embodiments, the imidazole of formula (I) is 2-methylimidazole.

Exemplary benzimidazole-based ligands that may be applicable to the current disclosure include, but are not limited to, benzimidazole, 5-methylbenzimidazole, 2-methylbenzimidazole, 5-chlorobenzimidazole, 5-bromobenzimidazole, 5,6-dimethylbenzimidazole, 5-methoxybenzimidazole, 2-chlorobenzimidazole, 2-bromo-1H-benzimidazole, 6-bromo-1H-benzimidazole, 5-fluoro-1H-benzimidazole, 5-chloro-2-methylbenzimidazole, methyl benzimidazole-2-acetate, 1H-benzoimidazol-4-ol, 1H-benzimidazol-5-ylmethanol, 2-benzimidazolemethanol, 4-chloro-6-(trifluoromethyl)benzimidazole, 5-chloro-2-(trichloromethyl)benzimidazole, 5-cyanobenzimidazole, (2-benzimidazolyl)acetonitrile, (5-chloro-1H-benzimidazol-2-yl)methanol, 2-(chloromethyl)benzimidazole, 5-iodo-2-methylbenzimidazole, (5-chloro-1H-benzimidazol-2-yl)methylamine, 2-(aminomethyl)benzimidazole, 2-(6-chloro-1H-benzimidazol-2-yl)ethanol, 2-(1H-benzoimidazol-2-yl)-acetamide, (6-methoxy-1H-benzimidazol-2-yl)methanol, 5,6-dimethoxybenzimidazole, 2-(1H-benzoimidazol-2-yl)-ethylamine, 1-(5-methyl-1H-benzimidazol-2-yl)methanamine, 1-(5-methyl-1H-benzimidazol-2-yl)ethanamine, 2-benzimidazolepropionic acid, 2-(5-methyl-1H-benzimidazol-2-yl)ethanamine, 2-(3-hydroxy-N-propyl)-5-(trifluoromethyl)-benzimidazole, and N-methyl-1-(5-methyl-1H-benzimidazol-2-yl)methanamine. In preferred embodiments, the benzimidazole of formula (II) is 5-methylbenzimidazole.

In one or more embodiments, a molar ratio between the imidazole of formula (I) to the benzimidazole of formula (II) ranges from 1:1 to 1:4, preferably 2:3 to 2:7, more preferably 4:7 to 1:3, even more preferably 5:9 to 2:5, or about 1:2.

The metal-organic framework filler comprises a metal ion which is an ion of at least one metal selected from the group consisting of a transition metal (e.g. Sc, Ti, V, Cr, Mn, Fe, Co, Ni, Cu, Y, Zr, Nb, Mo, Tc, Ru, Rh, Pd, Ag, Hf Ta, W, Re, Os, Ir, Pt, Au, Rf, Db, Sg, Bh, Hs, Mt, Ds, Rg, and Cn), a post-transition metal (e.g. Al, In, Ga, Sn, Bi, Pb, TI, Zn, Cd, and Hg), and an alkaline earth metal (e.g. Be, Mg, Ca, Sr, Ba, and Ra). Further, these metal ions may be of any oxidation state M⁺¹, M⁺², M⁺³, etc. In one or more embodiments, the metal ion is an ion of at least one metal selected from the group consisting of Zn, Cu, Fe, Ni, Co, Mn, Cr, Cd, Mg, Ca, and Zr. In a preferred embodiment, the at least one metal is Zn. In another preferred embodiment, the metal ion is preferably Cu(II).

In the formation of a metal organic framework, the organic ligands must meet certain requirements to form coordination bonds, primarily being multi-dentate, having at least two donor atoms (i.e. N-, and/or O-) and being neutral or anionic. The structure of the metal organic framework is also affected by the shape, length, and functional groups present in the organic linker. In certain embodiments, the metal organic framework of the present disclosure comprises anionic ligands as organic ligands. In one or more embodiments, the organic ligands may have at least two nitrogen donor atoms. For example, the organic ligands may be imidazolate-based, imidazole-derived or ligands similar to an imidazole including, but not limited to, optionally substituted imidazoles, optionally substituted benzimidazoles, optionally substituted imidazolines, optionally substituted pyrazoles, optionally substituted thiazoles, and optionally substituted triazoles. In a preferred embodiment, the metal organic framework of the present disclosure in any of its embodiments comprises 2-methylimidazole and 5-methylbenzimidazole as the organic ligands. 2-Methylimidazole and 5-methylbenzimidazole organic ligands have free nitrogen atoms that may each form a coordinative bond to the metal ions (e.g. Zn(II)) to produce a coordination network.

In one or more embodiments, the metal-organic framework filler comprises at least one ZIF selected from the group consisting of ZIF-300, ZIF-301, and ZIF-302. In preferred embodiments, the metal-organic framework filler comprises ZIF-302. Other metal-organic frameworks that may be used in the currently disclosed membrane include, but are not limited to, isoreticular metal organic framework-3 (IRMOF-3), ZIF-8-90, ZIF-8-90-EDA, MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH2, UMCM-1-NH2, MOF-69-80, ZIF-1, ZIF-2, ZIF-3, ZIF-4, ZIF-5, ZIF-6, ZIF-7, ZIF-8, ZIF-9, ZIF-10, ZIF-1, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, and ZIF-725.

A particle is defined as a small object that behaves as a whole unit with respect to its transport and properties. The metal-organic framework filler of the present disclosure in any of its embodiments may be in the form of particles of the same shape or different shapes, and of the same size or different sizes. An average diameter (e.g., average particle diameter) of the particle, as used herein, refers to the average linear distance measured from one point on the particle through the center of the particle to a point directly across from it. The metal-organic framework filler particles may have an average diameter in a range of 0.1-10 μm, 0.2-7 μm, 0.3-5 μm, 0.4-4 μm, 0.5-3 μm, 0.6-2 μm, or 0.7-1 μm. The metal-organic framework filler particles may be agglomerated or non-agglomerated (i.e., the metal-organic framework filler particles are well separated from one another and do not form clusters). In one embodiment, the metal-organic framework filler particles are agglomerated and the agglomerates have an average diameter in a range of 1-100 μm, 2-50 μm, or 5-25 μm.

In one or more embodiments, the metal-organic framework filler particles are block-shaped. For example, the metal-organic framework filler particles may be in the form of a cube, a cuboid, a hexagonal prism, a triangular prism, a triangular-based pyramid, a square-based pyramid, or other polyhedron shapes. Alternatively, the metal-organic framework filler particles may be spherical or substantially spherical (e.g., oval or oblong shape). In some embodiments, the metal-organic framework particles are in the form of at least one shape such as a sphere, a rod, a cylinder, a prism, a disk, a platelet, a flake, and an urchin (e.g., a globular particle possessing a spiky uneven surface).

The metal-organic framework filler may be uniform. As used herein, the term “uniform” refers to no more than 10%, no more than 5%, no more than 4%, no more than 3%, no more than 2%, or no more than 1% of the distribution of the metal-organic framework filler particles having a different shape. For example, the metal-organic framework filler particles are uniformly cuboids and have no more than 2% of metal-organic framework filler particles are in a sphere shape. In some embodiments, the metal-organic framework filler particles may be non-uniform. As used herein, the term “non-uniform” refers to more than 10% of the distribution of the metal-organic framework filler particles having a different shape.

Dispersity is a measure of the heterogeneity of sizes of molecules or particles in a mixture. In probability theory and statistics, the coefficient of variation (CV), also known as relative standard deviation (RSD) is a standardized measure of dispersion of a probability distribution. It is expressed as a percentage and is defined as the ratio of the standard deviation (σ) of to the mean (μ, or its absolute value |μ|). The CV or RSD is widely used to express precision and repeatability. It shows the extent of variability in relation to the mean of a population. The metal-organic framework filler particles having a narrow size dispersion, i.e., monodispersity, is preferred. As used herein, “monodisperse”, “monodispersed” and/or “monodispersity” refers to metal-organic framework filler particles having a CV or RSD of less than 25%, preferably less than 20%.

The metal-organic framework filler particles may be monodisperse with a coefficient of variation or relative standard deviation (ratio of the particle size standard deviation to the particle size mean) of less than 15%, less than 12%, less than 10%, less than 9%, less than 8%, less than 7%, less than 6%, less than 5%, or preferably less than 2%.

The metal-organic framework filler may be mesoporous or microporous. In one embodiment, the metal-organic framework filler has a BET surface area in a range of 300-500 m²/g, 350-450 m²/g, 375-400 m²/g, or about 380 m²/g. In another embodiment, the metal-organic framework filler has a Langmuir surface area in a range of 400-600 m²/g, 450-550 m²/g, 460-500 m²/g, or about 470 m²/g.

In one or more embodiments, the aforementioned metal-organic framework filler is embedded in the polymer matrix at an amount of 0.1-50 wt %, preferably 1-10 wt %/o, more preferably 2-8 wt %, even more preferably 4-6 wt %, or about 5 wt % relative to a total weight of the membrane. The polymer matrix may encapsulate the metal-organic framework filler and optionally fill at least some of the pores of the filler. The polymer matrix may interact with the surface and/or the pores of the metal-organic framework filler via van der Waals forces and/or x-x interactions (for polymer matrixes containing an aryl group such as phenyl, naphthyl, anthracenyl, thienyl, and indolyl). The polymer matrix may fill the interspaces between metal-organic framework filler particles.

The metal-organic framework filler is preferably dispersed in the polymer matrix. In an embodiment where the metal-organic framework filler is well dispersed (i.e., not agglomerated), the metal-organic framework filler may be evenly dispersed (i.e., a distance between a metal-organic framework filler particle and all its neighbors is the same or substantially the same) or randomly dispersed (i.e., the distance between a metal-organic framework filler particle and all its neighbors are different). The distance can be said to be substantially the same when the shortest distance is at least 80%, at least 85%, at least 90%, or at least 95% of the average distance and the longest distance is not more than 120%, not more than 110%, or not more than 105% of the average distance. The distance is measured from a center of a metal-organic framework filler particle to a neighboring metal-organic framework filler particle and may be in a range of 0.1 nm to 1 μm, 1-500 nm, 10-200 nm, or 50-100 nm. Energy-dispersive X-ray spectroscopy, X-ray microanalysis, elemental mapping, transmission electron microscopy, scanning electron microscopy, and scanning transmission electron microscopy may be useful techniques for observing the dispersion of the metal-organic framework filler in the polymer matrix.

The membrane may have a permeability of at least 100 barrer, at least 200 barrer, at least 250 barrer, at least 300 barrer, at least 320 barrer, and up to 500 barrer, up to 400 barrer, up to 375 barrer, or up to 350 barrer, for hydrogen gas. The membrane may have a permeability of at least 10 barrer, at least 20 barrer, at least 30 barrer, at least 35 barrer, or at least 40 barrer, and up to 70 barrer, up to 60 barrer, or up to 50 barrer, for oxygen gas. The membrane may have a permeability of at least 2 barrer, at least 4 barrer, at least 5 barrer, at least 6 barrer, and up to 15 barter, up to 12 barrer, or up to 8 barrer, for nitrogen gas. The membrane may have a permeability of at least 80 barrer, at least 100 barrer, at least 120 barrer, or at least 140 barrer, and up to 200 barrer, up to 180 barrer, or up to 160 barrer, for carbon dioxide gas. The membrane may have a permeability of at least 2 barrer, at least 4 barrer, at least 6 barrer, or at least 8 barrer, and up to 20 barrer, up to 15 barrer, or up to 12 barrer, for methane. The permeability measurements may be taken at an upstream pressure of 1.1-5 bar, 1.5-4 bar, or 1.8-2.5 bar, and the membrane may be pre-evacuated at 20-50° C., 30-45° C., or 33-40° C.

The membrane disclosed herein in any of its embodiments may have a permeability which is at least 50 times, at least 75 times, or at least 100 times, and up to 200 times, up to 180 times, up to 160 times, up to 140 times, or up to 120 times the gas permeability of a pure, dense polymeric membrane (i.e., a membrane without pores and devoid of metal-organic framework filler). The membrane may have a permeability which is at least 20 times, at least 40 times, or at least 60 times, and up to 100 times, up to 90 times, up to 80 times, up to 70 times, or up to 65 times the gas permeability of a dense membrane that contains the metal-organic framework filler described herein but does not have a spongy morphology.

Barrer is a non-SI unit of gas permeability used in the membrane technology.

$$1 barrer = 1 {0}^{- 10} \frac{c {m}_{S T P}^{3} \cdot cm}{c {m}^{2} \cdot s \cdot cmHg}$$

Here, the term “cm³_{STP}” is standard cubic centimeter, which is a unit of amount of gas rather than a unit of volume. It represents the amount of gas molecules or moles that would occupy one cubic centimeter at standard temperature and pressure, as calculated via the ideal gas law. The term “cm” corresponds, in the permeability equations, to the thickness of the material whose permeability is being evaluated, the term “cm³_{STP} cm⁻²s⁻” corresponds to the flux of gas through the material, and the term “cmHg” corresponds to the pressure drop across the material. Thus, “barrer” is a measure of the rate of fluid flow through an area of material with a thickness driven by a given pressure. In SI units, 1 barrer is equivalent to 3.34×10⁻¹⁶ mol Pa⁻¹-s⁻¹ m⁻¹.

As used herein, the term “ideal selectivity” refers to a ratio between the permeability of the gases. In one embodiment, the membrane disclosed herein has an ideal selectivity of hydrogen over a gas selected from the group consisting of oxygen, nitrogen, carbon dioxide and methane in a range of 1.2-120, 2-100, 3-70, 4-50, or 5-30. In another embodiment, the membrane has an ideal selectivity of carbon dioxide over a gas selected from the group consisting of nitrogen and methane in a range of 5-50, 10-40, 15-35, or 20-30.

The ideal selectivity of H₂/N₂ of the membrane may be at least 40, at least 50, or at least 60, and up to 100, up to 90, or up to 80. The ideal selectivity of H₂/O₂ of the membrane may be at least 5, at least 8, or at least 10, and up to 25, up to 20, or up to 15. The ideal selectivity of H₂/CO₂ of the membrane may be at least 1.5, at least 2, or at least 2.5, and up to 8, up to 6, or up to 4. The ideal selectivity of H₂/CH₄ of the membrane may be at least 35, at least 50, or at least 55, and up to 110, up to 90, or up to 70. The ideal selectivity of CO₂/N₂ of the membrane may be at least 15, at least 20, or at least 25, and up to 50, up to 40, or up to 30. The ideal selectivity of CO₂/CH₄ of the membrane may be at least 15, at least 18, or at least 22, and up to 40, up to 35, or up to 30.

Preparation techniques to prepare porous symmetric membranes include, but are not limited to, irradiation, stretching of a melt-processed semi-crystalline polymer substrate, vapor-induced phase separation, and temperature-induced phase separation.

According to a second aspect, the present disclosure relates to a method of producing the membrane of the first aspect in which the polymer matrix comprises the polyimide. The method involves: (i) suspending the metal-organic framework filler in a first solvent to form a suspension, (ii) dissolving the polyimide in a second solvent to form a solution, (iii) mixing the suspension with the solution to form a mixture, (iv) casting the mixture to form a membrane blend, (v) coagulating the membrane blend at a temperature of 20-90° C., 25-85° C., 30-80° C., 40-70° C., or 50-60° C. for 18-36 hours, 20-32 hours, 22-30 hours, or 24-28 hours to form a coagulated membrane, and (vi) drying the coagulated membrane at a temperature of 150-250° C., 155-225° C., 160-200° C., 165-180° C., or about 170° C. for 6-24 hours, 7-20 hours, 8-18 hours, 9-16 hours, 10-14 hours, or about 12 hours, thereby forming the membrane.

The solvents used for suspending the metal-organic framework filler and for dissolving the polymer are chosen primarily for their ability to completely dissolve the polymers and for ease of solvent removal in the membrane formation steps. Other considerations in the selection of solvents include low toxicity, low corrosive activity, low environmental hazard potential, availability, and cost. Preferred solvents include most amide solvents (e.g., N-methylpyrrolidone (NMP), dimethylformamide (DMF), formamide, N-methyl formamide, 2-pyrrolidone, and dimethylacetamide (DMA)), methylene chloride, THF, acetone, DMSO, toluene, dioxanes, 1,3-dioxolane, and mixtures thereof. In a preferred embodiment, the first solvent is dimethylacetamide. In a preferred embodiment, the second solvent comprises dimethylacetamide and dimethylformamide.

An amount of the metal-organic framework filler in the suspension may be in a range of 1-1,000 g/L, 5-500 g/L, 10-250 g/L, 25-150 g/L, or 50-100 g/L, relative to the volume of the first solvent. An amount of the polyimide in the solution may be in a range of 100-4,000 g/L, 150-2,000 g/L, 200-1,000 g/L, or 250-500 g/L, relative to the volume of the second solvent. The polyimide may be dissolved at 35-60° C., 40-55° C., or 45-50° C., under reduced pressure for a duration in a range of 10-30 hours, 12-25 hours, or 18-24 hours. The reduced pressure may range from 0.01-400 mbar, preferably 0.1-200 mbar, more preferably 1-50 mbar. A weight ratio of the metal-organic framework filler to the polyimide may be in a range of 1:99 to 1:1, 1:50 to 1:2, 1:25 to 1:3, 1:10 to 1:4, or about 1:5.

In one or more embodiments, the suspension is mixed with the solution for a period of 6-24 hours, 8-20 hours, 10-15 hours, or about 12 hours at 30-60° C., 35-55° C., 40-50° C., or about 45° C. under reduced pressure to form a mixture. The reduced pressure may range from 0.01-400 mbar, preferably 0.1-300 mbar, more preferably 1-50 mbar. The suspension may be mixed with the solution via agitation. Methods of agitation include, without limitation, swirling by hand, stirring with a magnetic stir plate or a mechanical stirrer, shaking with a rotary shaker, sonicating using an ultrasonic bath or an ultrasonic probe. In a preferred embodiment, the suspension is mixed with the solution using a magnetic stirrer at a speed of 100-800 rpm, 200-600 rpm, or 300-500 rpm. An external heat source, such as a water bath or an oil bath, an oven, microwave, a thermostatted thermocirculator, or a heating mantle, may be employed to heat the mixture.

To fabricate the membrane blend, the mixture may be cast by a continuous single step extrusion film process, flow coating, spin casting, or solvent casting. In one embodiment, the mixture may be cast onto a glass plate and a casting knife may be used for spreading the mixture across the glass plate to produce a membrane blend with a uniform thickness of 10-2,000 μm, 25-1,500 μm, 50-1,000 μm, 100-800 μm, 200-600 μm, 250-500 μm, or about 300 μm. In at least one embodiment, the membrane blend is coagulated at a first temperature of 10-40° C., 15-35° C., or 20-30° C. under open air conditions for 4-24 hours, 6-20 hours, or 8-16 hours and coagulated at a second temperature of 60-110° C., 70-100° C., 75-90° C., or about 80° C. for 1-24 hours, 2-18 hours, 4-12 hours, or 6-8 hours to form a coagulated membrane. After evaporation of the solvent, the coagulated membrane may be peeled off from the glass plate. The coagulated membrane may be further dried at a temperature of 100-300° C., 125-275° C., 150-250° C., 160-225° C., 165-200° C., or about 170° C. for 6-36 hours, 8-24 hours, 9-18 hours, 10-14 hours, or about 12 hours to form the membrane.

According to a third aspect, the present disclosure relates to a method of recovering a first gas from a gas mixture comprising the first gas and a second gas. The method involves delivering the gas mixture into a feed side of a chamber comprising the membrane of the first aspect that divides the chamber into the feed side and a permeate side, such that at least a portion of the first gas permeates the membrane, and recovering from the permeate side a stream enriched in the first gas compared to the gas mixture. The stream enriched in the first gas may be subjected to further processing steps such as an additional purification step (e.g. column chromatography, further membrane separation steps, etc.).

In one or more embodiments, a force is provided to deliver the gas mixture into the feed side. For example, the gas mixture introduced into the feed side of the chamber has a pressure of 1-5 bar, preferably 1.1-4 bar, preferably 1.2-3 bar, preferably 1.3-2.5 bar, preferably 1.4-2.3 bar, preferably 1.5-2.2 bar. In one embodiment, the method also involves applying a reduced pressure (i.e. vacuum) to the permeate side of the chamber. In one or more embodiments, the gas mixture is introduced at a temperature of 20-60° C., 25-50° C., 30-40° C., or about 35° C.

Gases that may be separated by the membrane disclosed herein in any of its embodiments include, without limitation, hydrogen, carbon dioxide, carbon monoxide, oxygen, nitrogen, hydrocarbons having 1-4 carbon atoms (e.g. methane, ethane, ethylene, acetylene, propane, propylene, butane, iso-butane), and noble gases (e.g. helium, neon, argon, krypton, xenon). In a preferred embodiment, the first gas is hydrogen, carbon dioxide, or both, and the second gas is at least one selected from the group consisting of oxygen, nitrogen, and methane.

Any given pair or group of gases that differ in molecular sizes, for example, hydrogen and nitrogen, hydrogen and oxygen, hydrogen and carbon dioxide, hydrogen and methane, hydrogen and ethane, hydrogen and ethylene, hydrogen and propane, hydrogen and propylene, carbon dioxide and nitrogen, carbon dioxide and methane, carbon dioxide and ethane, carbon dioxide and ethylene, carbon dioxide and propane, carbon dioxide and propylene, nitrogen and oxygen, helium and methane, may be separated using the membrane described herein. More than one gas may be removed from the gas mixture. For example, a stream enriched in the first gas compared to the gas mixture may be recovered from the permeate side by removing the second gas including oxygen, nitrogen, and/or methane.

In some embodiments, the method is useful in enriching hydrogen gas from a gas mixture comprising hydrogen gas and nitrogen gas, or hydrogen gas from a gas mixture comprising hydrogen gas and carbon dioxide gas, or hydrogen gas from a gas mixture comprising hydrogen gas and methane gas. In other embodiments, the method is useful in enriching carbon dioxide gas from a gas mixture comprising carbon dioxide gas and nitrogen gas, or carbon dioxide gas from a gas mixture comprising carbon dioxide gas and methane gas.

The chamber used for separating the gas mixture may be of any shape so long as the membrane can be securely housed and utilized inside the chamber to accomplish the gas mixture separation. For example, the chamber may be a cylindrical membrane module. The chamber may also include an inlet configured to accept feed material, a first outlet configured to expel a retentate, and a second outlet configured to expel a permeate. The chamber can be configured to be pressurized so as to push feed material though the inlet, retentate through the first outlet and permeate through the second outlet. The chamber may also include a vacuum pump to provide vacuum or a reduced pressure to the permeate side. Further, it is contemplated that at least 2, 3, 4 or more of the same or different membranes disclosed herein may be used in series with one another to further enrich or isolate a targeted gas from a gas mixture. Similarly, the membranes may be used in series with other currently known membranes to enrich or isolate a targeted gas from a gas mixture.

In addition to gas separation and enrichment, the membranes disclosed herein may be used in separation of liquid mixtures by pervaporation, water treatment, air purifiers, chemical filters, oil and gas refineries, fermenters, and bioreactors.

The examples below are intended to further illustrate protocols for preparing, characterizing and utilizing the membrane, and are not intended to limit the scope of the claims.

### Example 1

### Preparation of Polyimide Membrane

In a typical procedure, polyimide (PI) was activated via heating at 120° C. for 30 min. 0.625 g of the activated PI was dissolved in a solvent mixture of 2.4 mL DMA and 0.4 mL DMF in a 20 mL vial over 12 h at 45° C. with stirring at 300 rpm under vacuum. The resulting homogeneous solution was casted onto a clean glass plate with the aid of casting knife, which was adjusted to 300 μm thickness. In order to fabricate the dense membranes, the casted PI was directly placed in the oven at 120° C. for 5 h for coagulation. On the other hand, to fabricate the spongy membranes, the casted PI was allowed to coagulate under open air conditions for 24 h followed by the temperature rise to 80° C. All the resulting dense and spongy membranes were peeled from the glass, and placed in oven at 170° C. for 12 h to remove residual solvent.

### Example 2

### Defect Treatment of Polyimide Spongy Membranes

Polydimethylsilane (PDMS, 6 mL) was dissolved in n-hexane (20 mL) and used in the defect treatment of the spongy membrane. The membranes were immersed in the solution for 10 s and then allowed to dry for at least 24 h under open air conditions prior to permeation measurements.

### Example 3

### Synthesis & Characterization of ZIF-302: Chemicals and General Procedures

All reagents were used as received without further purification. Zinc nitrate hexahydrate (Zn(NO₃)₂.6H2O, ≥99% purity) was obtained from Loba, Mumbai, India. 2-methylimidazolate (2-mImH, ≥97% purity), 5-methyl-benzimidazolate (mbImH, ≥98% purity) and polyimide resin powder (PI) were purchased from Alfa Aeser. N,N′-Dimethylformamide (DMF, ≥99.5% purity) and methanol (≥99.9% purity) were purchased from Scharlau. N,N′-Dimethylacetamide (DMA, ≥99%4 purity), deuterated dimethyl sulfoxide (DMSO-d₆, 99.9%), and deuterium chloride (35% DCI in D2O) were purchased from Aldrich Chemical Co. H₂ (99.999%) and CH₄ (99.9%) were purchased form Abdullah Hashem Industrial Gas Co., Dammam, Saudi Arabia. CO₂ (99.9%), N₂ (99.999%), and O₂ (99.9%) were purchased from Air Liquide, Dammam, Saudi Arabia. Powder X-ray diffraction (PXRD) patterns were collected on a Bruker D8 Advance employing Ni-filtered Cu Kα radiation (A=1.54178 Å). ¹H nuclear magnetic resonance (NMR) spectroscopy measurements were carried out using a JEOL JNM-LA500 spectrometer at 500 MHz. All chemical shifts were referenced relative to trimethylsilane. Field emission scanning electron microscopy (SEM) analysis was performed using gold sputtered samples on a JEOL JSM 6610 LV with an accelerating voltage of 20 kV, and energy-dispersive X-ray spectroscopy (EDX) analysis was measured using an Oxford Instrument X-MaxN silicon drift detector. Thermogravimetric analysis (TGA) was conducted using a TA Q500 with the sample held in a platinum pan under airflow. Fourier transform infrared (FT-IR) spectroscopy was performed using a Nicolet NXR FT-Raman spectrometer with a single reflection diamond plate. Samples activation was performed XeriPrep Degasser from Quantachrome. Brunauer-Emmett-Teller (BET) and sorption measurements were carried out on Autosorb iQ2 from Quantchrome.

### Example 4

### Synthesis & Characterization of ZIF-302: Synthesis of ZIF-302

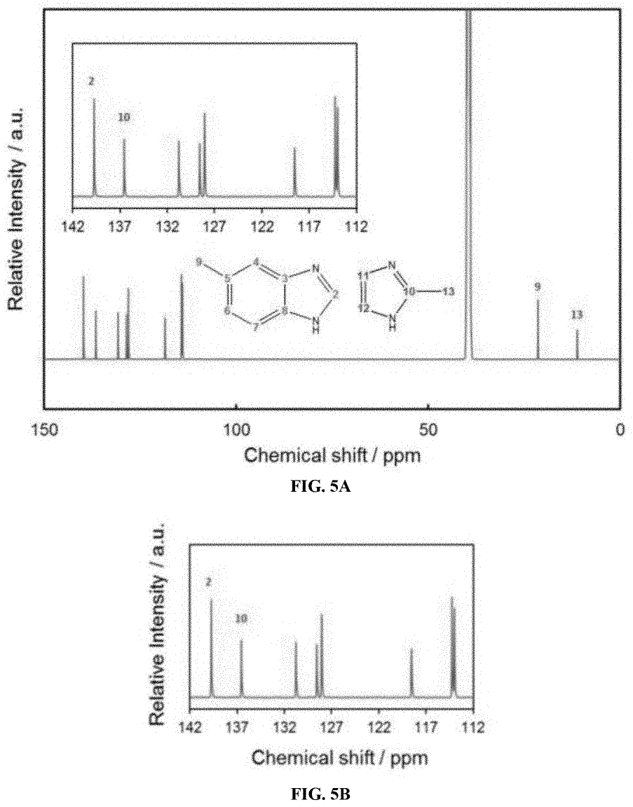

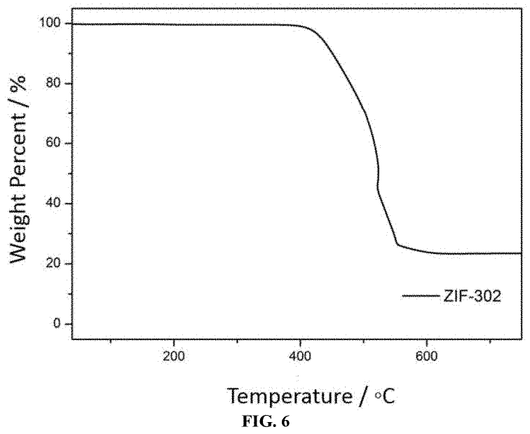

ZIF-302 microcrystals were synthesized following a slight modification of a previously reported procedure [Nguyen, N. T. T. et al. Selective capture of carbon dioxide under humid conditions by hydrophobic chabazite-type zeolitic imidazolate frameworks. Angew. Chem. Int. Ed. 53, 10645-10648 (2014), incorporated herein by reference in its entirety]. Zn(NO₃)₂.6H₂O (0.51 g, 1.7 mmol), 2-methylimidazole (2-mImH, 0.19 g, 2.2 mmol), and 5-methylbenzimidazole (5-mbImH, 0.40 g, 3.0 mmol) were dissolved in 22 mL DMF and 3 mL deionized water in a 100 mL round bottom flask. The flask was sealed and placed in an oil bath and heated at 120° C. with stirring for 3 d. The resulting white microcrystalline powder was isolated by centrifugation at 6,000 rpm for 5 min at 40-50% yield. The mother liquid was then discarded and the obtained powder was washed 3 times with 5 mL DMF followed by centrifugation and solvent decantation. The obtained powder was split into two portions, portion (i) was dedicated for the usage in various analyses, and portion (ii) was dedicated for the use in membrane fabrication. DMF in portion (i) was exchanged with DMA by the dispersion of the powder in 5 mL DMA for 3 times, while DMF in portion (ii) was exchanged with methanol by the dispersion of the powder in methanol over a week with daily solvent refreshing. The resulting powder was then activated by degassing at 180° C. for 2 h. ¹H and ¹³C NMR analyses were carried out on the activated ZIF-302 particles (See FIGS. 4 and 5). The dried solid (˜10 mg) was digested in 50 μL of DCI, and 500 μL of DMSO-d₆ was added once the solid was dissolved. FT-IR (4000-4000 cm⁻), 3450 (br), 2900 (m), 1700 (s), 1650 (m), 1500 (s), 1350 (s), 1250 (s), 1170 (s), 1000 (m), 940 (m), 820 (s), 750 (s), 680 (s), 490 (s).

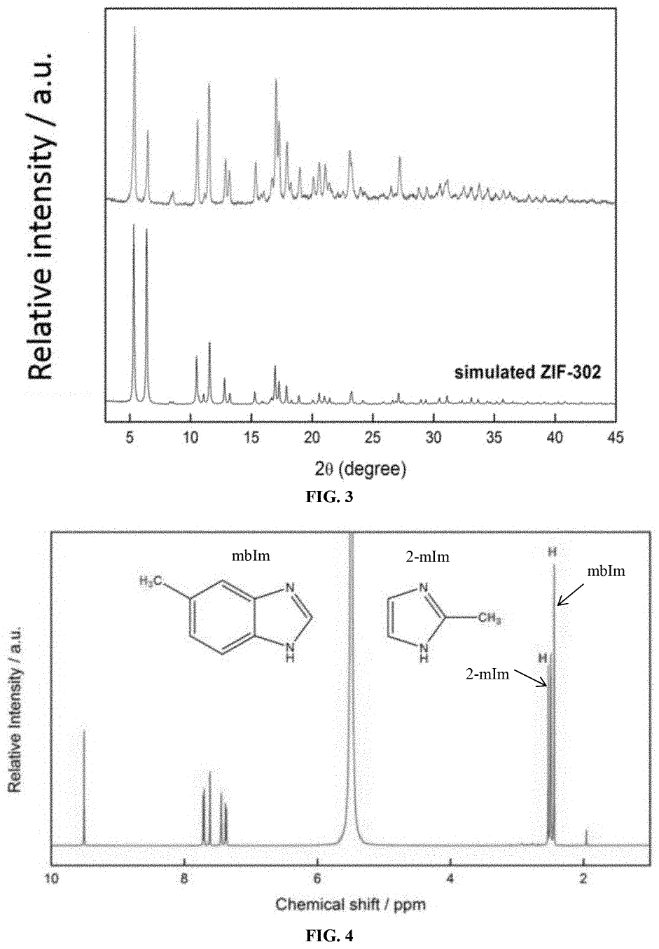

PXRD analysis of FIG. 3 shows a good match between PXRD patterns of experimental ZIF-302 and simulated ZIF-302.

¹H NMR spectrum of FIG. 4 shows the presence of 2-methylimidazole and 5-methylbenzimidazole linkers at a 1:2 ratio, which was calculated by comparing the areas under curve of ¹H NMR signals of methyl groups corresponding to each linker.

FIG. 6 shows the TGA curve of ZIF-302, which indicates a first weight loss after 400° C. demonstrating thermal stability of ZIF-302. In addition, the amount of residual ZnO loss resulted from complete combustion of ZIF-302 under air stream was −26 wt %, which was comparable to the theoretically accepted 26.67 wt % residue calculated from the chemical formula of ZIF-302 [Zn(2-mIm)_{0.67}(mbIm)_{1.33}-(H₂O)_{0.5}].

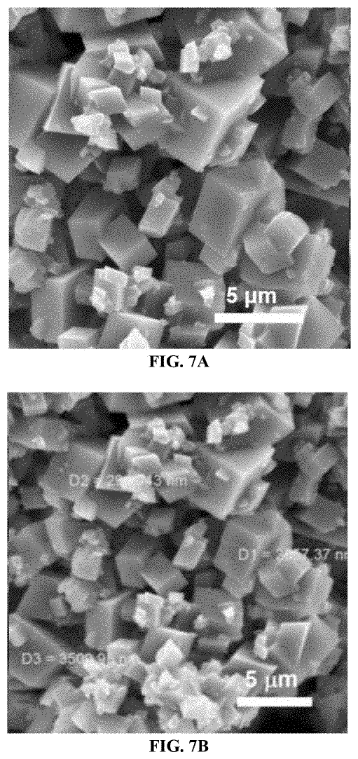

The SEM image of ZIG-302 particles in FIG. 7 demonstrates the particles have a block-shaped crystal morphology with a particle size of up to 3.5 μm.

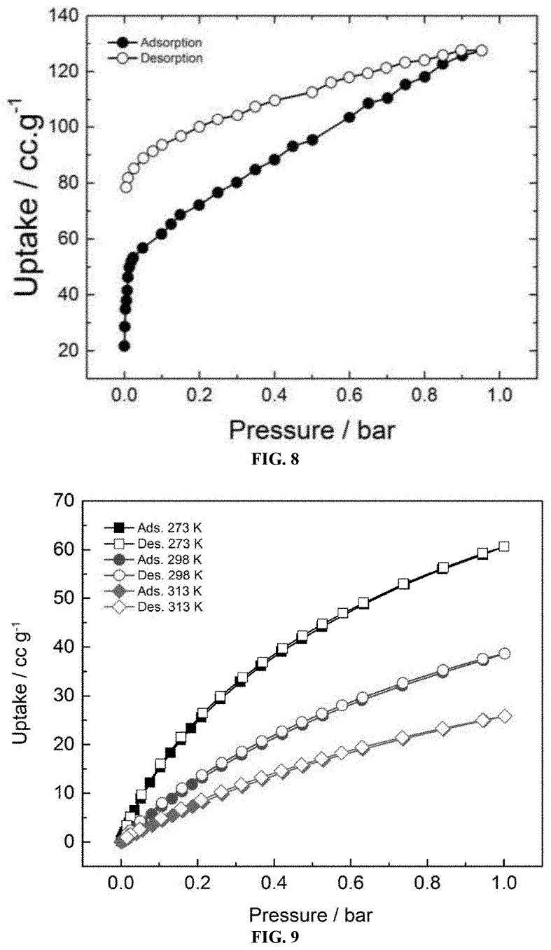

In FIG. 8, filled and open symbols each represent adsorption and desorption branches, respectively. The connecting curves are guides for eye. Brunauer-Emmett-Teller (BET) and Langmuir surface areas of the prepared ZIF-302 were 381 and 473 m²·g⁻¹, which were calculated from the N₂ isotherm at 77 K. It is worth noting that the N₂ isotherm shows a large hysteresis, which might result from the close size of the gas kinetic diameter to the framework aperture.

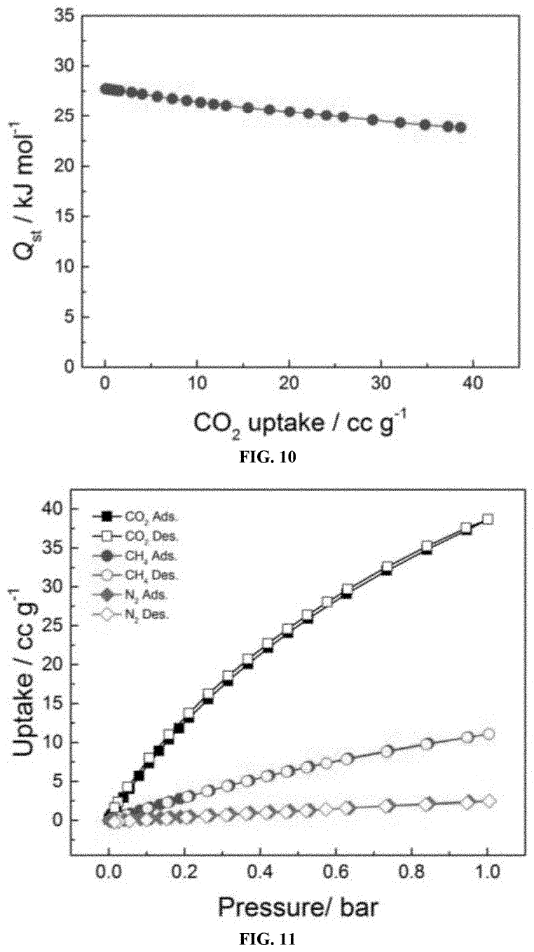

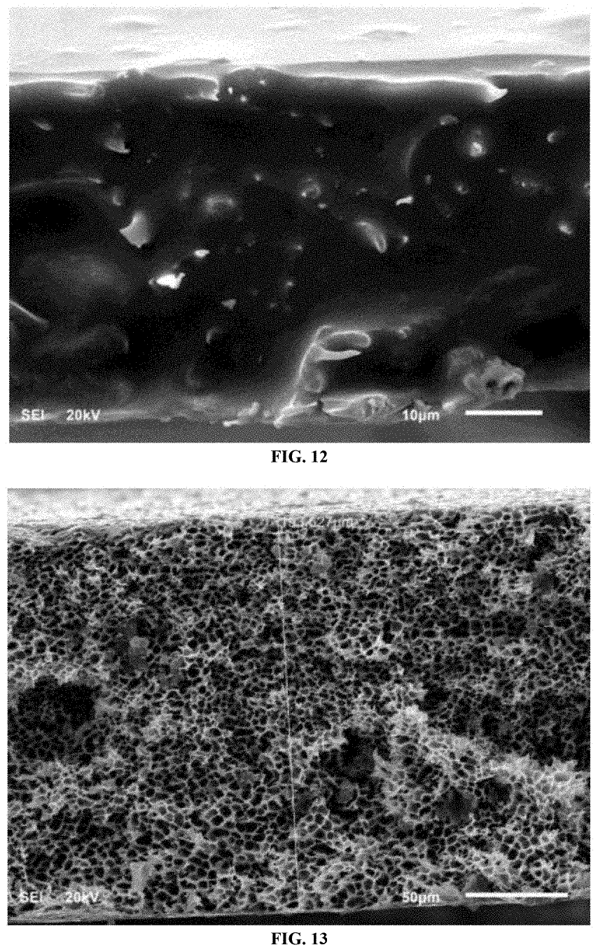

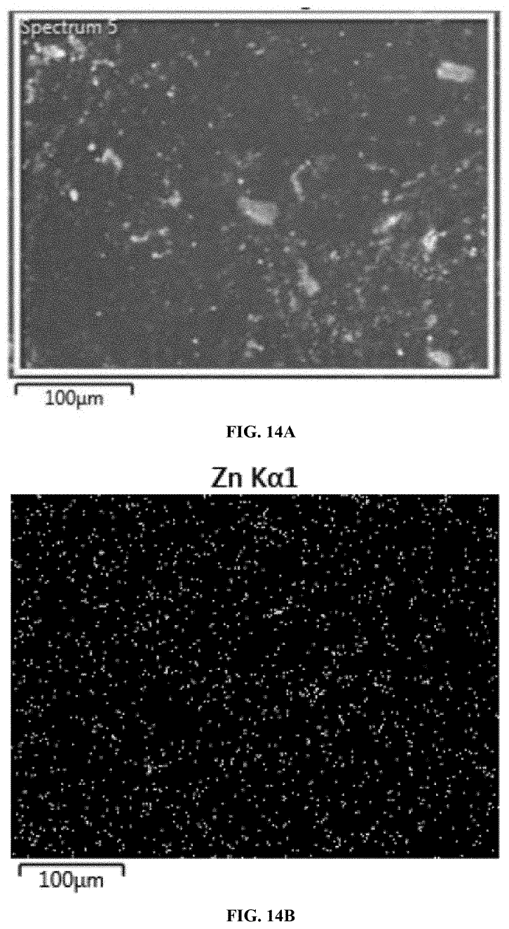

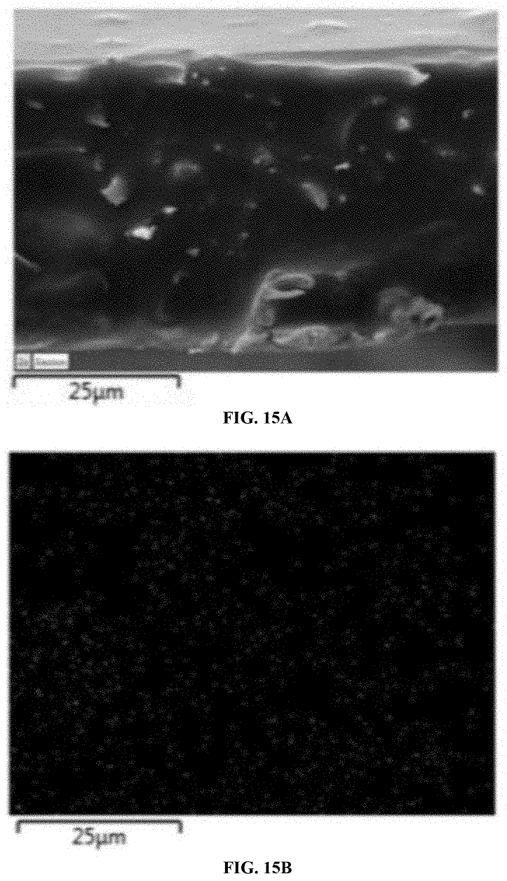

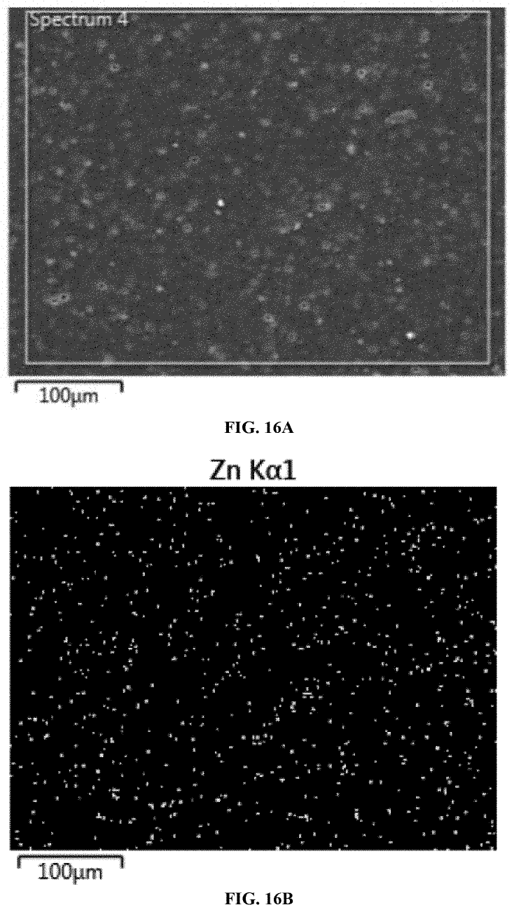

FIG. 10 shows the isosteric heat of adsorption (Qₛₜ) of ZIF-302 versus CO₂ uptake, which was found to be 27 kJ·mol⁻¹ at low loading.

FIG. 11 shows different sorption isotherms of CO₂, CH₄, and N₂ at 298 K, which revealed selectivities of CO₂/N₂ and CO₂/CH₄ at 16.6 and 3.3, respectively, calculated from the initial slope comparison according to Henry's law.

### Example 5

### Mixed Matrix Membrane Fabrication & Characterization: Preparation of ZIF-302-Polyimide Mixed-Matrix Membrane

In a typical procedure, polyimide (PI) was activated by heating at 120° C. for 30 min. 0.625 g of the activated PI was dissolved in the mixture of 33 mg of ZIF-302 suspended in 0.4 mL DMA, 2.0 mL DMA and 0.4 mL DMF in a 20 mL vial for 12 h at 45° C. with stirring at 300 rpm under vacuum to form a mixture. The mixture was then casted on a clean glass plate and adjusted to 300 μm thickness with the aid of casting knife. In order to fabricate the dense membranes, the casted ZIF-302:PI blend was directly placed in the oven at 120° C. for 5 h for coagulation. To fabricate the spongy membranes, the casted ZIF-302:PI blend was allowed to coagulate under open air conditions for 24 h followed by the temperature rise to 80° C. All the resulting dense and spongy membranes were peeled from the glass, and placed in oven at 170° C. for 12 h to remove residual solvent.

### Example 6

### Permeability Measurements

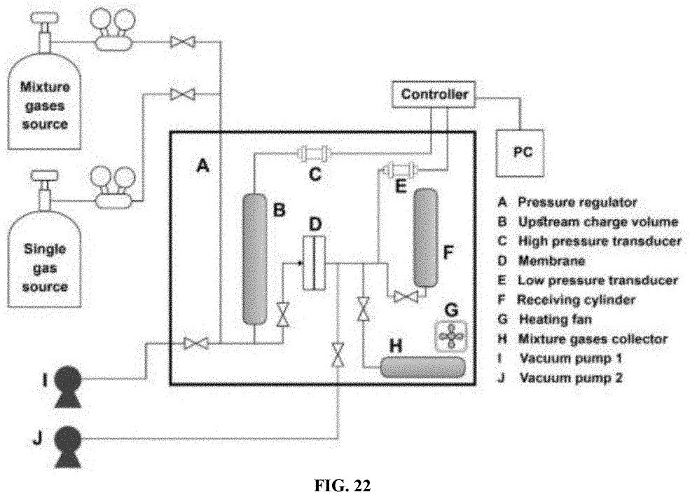

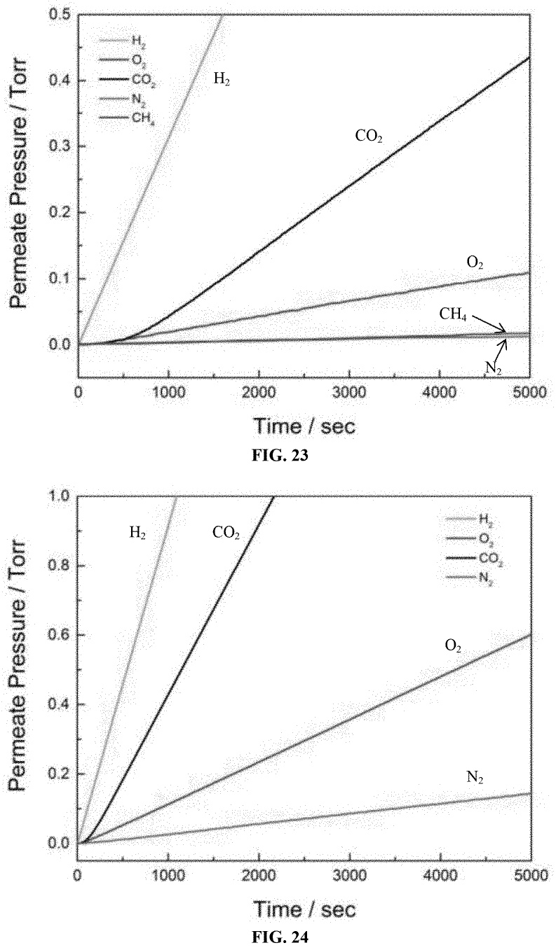

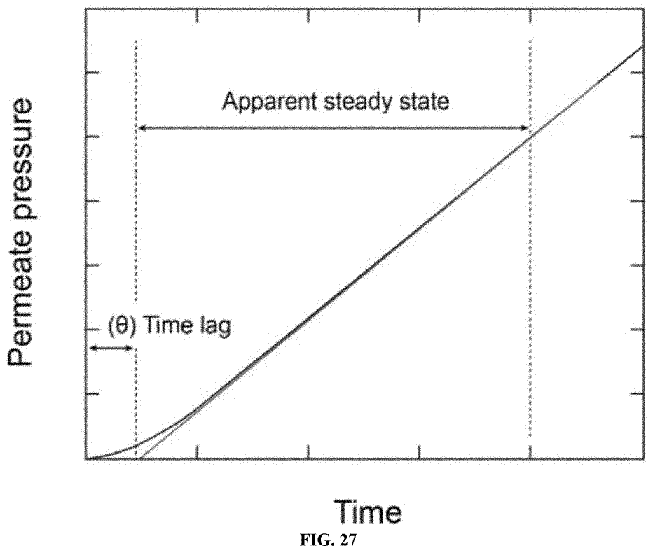

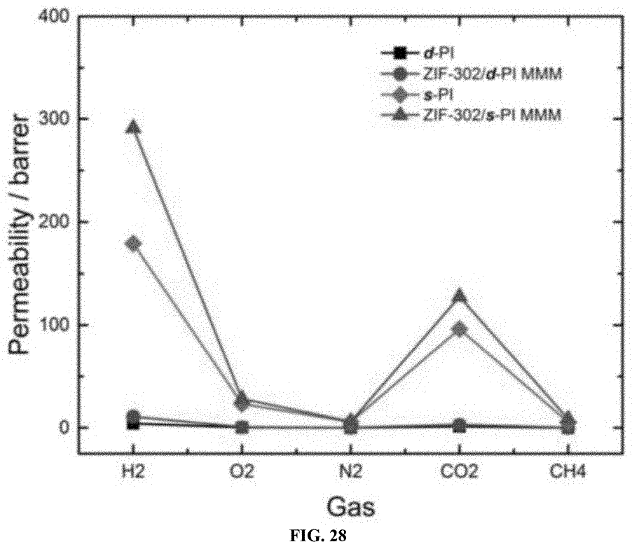

For the assessment of different membrane's effectiveness for gas separation applications, dense and spongy membranes were subjected to gas permeation experiments using constant volume/variable pressure CV/VP apparatus (FIG. 22). Each membrane was separately loaded into the membrane cell by fixing the membrane on a stainless-steel mesh from the permeate side and by a rubber O-ring from the feed side. The membrane holder was assembled in the CV/VP apparatus and subjected to vacuum from both sides for 24 hrs at 35° C. to ensure the complete removal of residual solvent molecules from the membrane. The sample was considered completely activated when the baseline pressure (25-35 mTorr) was obtained and no further loss in pressure was noticed. When the leak rate and the built-in pressure became ≤1×10⁻⁷ mTorr, the sample became ready for the permeation measurements. After the confirmation of the accepted leak rate, single gas permeation measurement was carried out by pressurizing the membrane from the feed side with different gases, separately, adjusted at 2 bar (pᵤₚ). The change of the pressure in the permeate side (dp_{down}) was monitored versus time (dₜ) and graphed for each gas. Permeation curves for different gases and membranes are presented in FIGS. 23-S26. The time-lag (θ) was calculated from the graph, and the steady state permeation rate (dp^{SS}/dt) was quested after 7-10 times θ (FIG. 27) which was used in calculating the gas permeability (Equation 1).

$$p = 1 {0}^{10} ( \frac{{d}_{{p}_{d}}^{SS}}{dt} - \frac{{d}_{{p}_{d}}^{LR}}{dt} ) \frac{{V}_{d} l}{( {P}_{up} - {P}_{d} ) ART} \qquad ( 1 )$$

Single gas permeability was measured for H₂, O₂, N₂, CO₂ and CH₄. Ideal selectivities (αⱼⁱ) of the more permeable gas (i) versus gas (j) were calculated from the obtained single gas data. Defect-free membrane quality was confirmed from the obtained time-lag and the resulting O₂/N₂ selectivity, which is higher than Knudsen diffusion selectivity (1.1) [1. Al-Maythalony, B. A. et al. Quest for Anionic MOF Membranes: Continuous sod-ZMOF Membrane with CO2 Adsorption-Driven Selectivity. J. Am. Chem. Soc. 137, 1754-1757 (2015), incorporated herein by reference in its entirety].

### Example 7

### Solution-Diffusion (SD) Model & Time-Lag Analysis

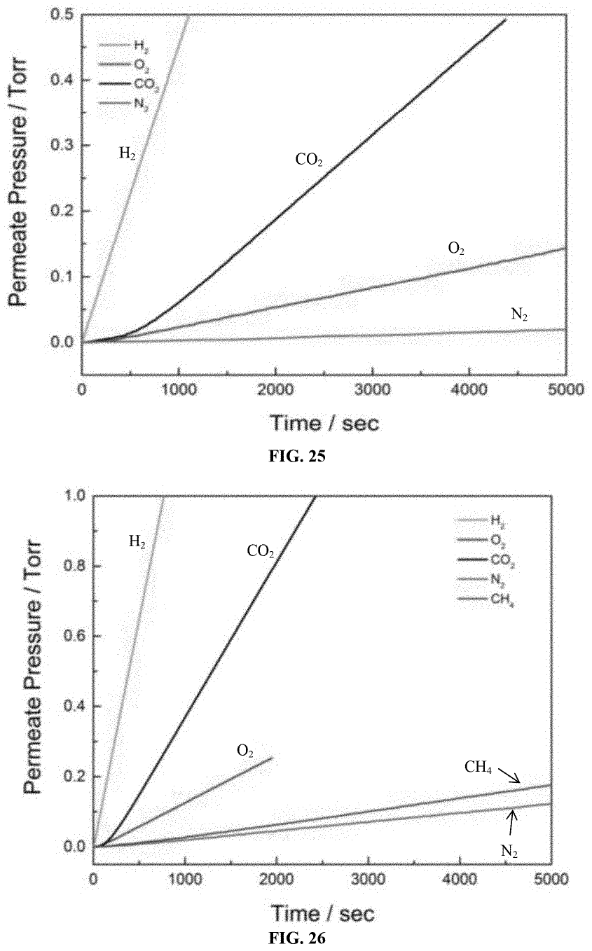

The SD model is applicable when the nominal pore diameter less than 10 Å³. Permeability (P) of the single gas was analyzed using SD model by considering: (i) diffusion coefficient (D), which reflects the kinetics of the gas transport across membrane and correlates with the gas diameter, expressed by Lennard Jones (L. J.) diameter, and (ii) solubility coefficient (S), which reflects the gas adsorption on the membrane material and correlates with the gas boiling point [Baker, R. W. Membrane technology and applications. John Wiley & Sons, Ltd, 96-103 (2004), incorporated herein by reference in its entirety]. Time-lag (θ), calculated from the permeation experiments (FIGS. 23-26), along with membrane thickness (l), were exploited for the experimental estimation of diffusion coefficients for different gases from the equation D=l²/6θ. In addition, solubility coefficients were derived from the experimental permeability and diffusivity coefficient of every single gas (Equations 1-4).

Permeability of the pure gas calculated from the equation:

$$p = 1 {0}^{10} ( \frac{{d}_{{p}_{d}}^{SS}}{dt} - \frac{{d}_{{p}_{d}}^{LR}}{dt} ) \frac{{V}_{d} l}{( {P}_{up} - {P}_{d} ) ART} \qquad ( 1 )$$

where P is the permeability coefficient in Barrer (10⁻¹⁰ cm³(STP) cm/(cm² s cmHg)), dp_{d}/dt^{SS} is the downstream pressure rise (cmHg/s) at the steady state, dp_{d}/dt^{LR} is the downstream “leak rate” (cmHg/s), V_{d} is the downstream volume (cm³), l is the membrane thickness (cm), pᵤₚ is the upstream pressure (cmHg), A is the membrane area (cm²), R is the gas constant [0.278 cm³ cmHg/(cm³(STP) K)], and T is the temperature during measurement (K).

The apparent diffusion coefficient calculated from the time lag θ (s) using the equation

$$D = \frac{{l}^{2}}{6 θ} ; \qquad ( 2 )$$

S solubility coefficient (cm³(STP)/(cm³ cmHg)) calculated from the equation, assuming permeation occurs via the solution-diffusion mechanism

$$S = \frac{P}{D} ; \qquad ( 3 )$$

Selectivity for a gas pair, i and j, is calculated by

$${α}_{j}^{i} = \frac{{P}_{i}}{{p}_{j}} . \qquad ( 4 )$$

TABLE 1
Permeabilities of different gases on d-PI membrane and their
corresponding MMMs with 5 wt % and 15 wt % ZIF-302 and the
s-PI membrane and its corresponding MMM of 5 wt % ZIF-302

| | | Permeability (barrer)^{a} | | | |
|---|---|---|---|---|---|
| | Kinetic | | 5 wt % ZIF- | | 5 wt % ZIF- |
| Gas | Diameter (Å) | d-PI | 302/d-PI | s-PI | 302/s-PI |
| H₂ | 2.89 | 4.25 | 11.22 | 179.1 | 314.7 |
| O₂ | 3.46 | 0.32 | 0.76 | 23.4 | 32.4 |
| N₂ | 3.64 | 0.05 | 0.12 | 6.0 | 5.1 |
| CO₂ | 3.3 | 1.38 | 3.18 | 96.2 | 135.0 |
| CH₄ | 3.8 | 0.04 | 0.10 | 5.8 | 6.2 |

^{a}Conditions for the CV/VP single gas permeation measurements: pre-evacuation at 35° C. followed by the introduction of an upstream pressure of 1520 Torr (2.03 bar) for each single gas measured. One barrer = 10⁻¹⁰ (cm³(STP) cm)/(cm² s cmHg).

TABLE 2
Ideal selectivity (α) of d-PI membrane and their corresponding
MMMs with 5 wt % and 15 wt % ZIF-302 and the s-PI membrane
and its corresponding MMM of 5 wt % ZIF-302

| | α^{a} | | | | |
|---|---|---|---|---|---|
| | | 5 wt % ZIF- | 15 wt % ZIF- | | 5 wt % ZIF- |
| Gas pair | d-PI | 302/d-PI | 302/d-PI | s-PI | 302/s-PI |
| O₂/N₂ | 6.6 | 6.6 | 8.1 | 3.9 | 6.0 |
| H₂/O₂ | 13.1 | 14.7 | 12.3 | 7.6 | 10.3 |
| H₂/N₂ | 85.8 | 96.9 | 99.4 | 30.0 | 61.3 |
| H₂/CO₂ | 3.1 | 3.5 | 3.0 | 1.9 | 2.3 |
| H₂/CH₄ | 106.8 | 110.2 | 92.3 | 31.1 | 51.0 |
| CO₂/N₂ | 27.4 | 16.1 | 33.1 | 11.9 | 26.3 |
| CO₂/CH₄ | 34.7 | 31.2 | 30.7 | 16.7 | 21.9 |
| N₂/CH₄ | 1.2 | 1.1 | 0.9 | 1.0 | 0.8 |

^{a}Permeability ratio of the gas with the higher permeation relative to the gas with the lower.

TABLE 3
Diffusion's coefficient results of the d-PI and s-PI membranes
compared with their corresponding 5 wt % ZIF-302 MMMs

| | L. J | | | | |
|---|---|---|---|---|---|
| | diameter | | 5 wt % | | 5 wt % |
| Gas | (Å) | d-PI | ZIF-302/d-PI | s-PI | ZIF-302/s-PI |
| H₂ | 2.83 | 1.05E−07 | 1.03E−06 | 7.36E−06 | 2.31E−05 |
| O₂ | 3.47 | 2.91E−09 | 5.65E−09 | 4.37E−07 | 5.31E−07 |
| CH₄ | 3.76 | 2E−09 | 1.45E−09 | — | 1.29E−07 |
| N₂ | 3.8 | 9.99E−10 | 2.02E−09 | 1.72E−07 | 1.92E−07 |
| CO₂ | 3.94 | 1.07E−09 | 3.99E−09 | 2.5E−07 | 2.98E−07 |

TABLE 4
Solubility's coefficient results of the d-PI and s-PI membranes
compared with their corresponding 5 wt % ZIF-302 MMMs

| | Boiling | | 5 wt % | | 5 wt % |
|---|---|---|---|---|---|
| Gas | point (K) | d-PI | ZIF-302/d-PI | s-PI | ZIF-302/s-PI |
| H₂ | 20.3 | 0.0040 | 0.0011 | 0.0024 | 0.0023 |
| O₂ | 90.2 | 0.0112 | 0.0135 | 0.0054 | 0.0061 |
| N₂ | 77 | 0.0050 | 0.0057 | 0.0035 | 0.0029 |
| CO₂ | 216.6 | 0.1295 | 0.0797 | 0.0385 | 0.0471 |
| CH₄ | 111 | — | 0.0070 | — | 0.0055 |

TABLE 5
Gas permeabilities and selectivities versus time (in days)
that shows the membrane stability over time after the
first preparation and over the measurement period

| | Permeability (barrer)^{a} | | | α^{b} | | |
|---|---|---|---|---|---|---|
| Days | H₂ | CO₂ | N₂ | H₂/CO₂ | H₂/N₂ | CO₂/N₂ |
| 140 | 332.7 | 139.5 | 5.0 | 2.4 | 66.0 | 27.7 |
| 165 | 301.1 | 129.7 | 5.3 | 2.3 | 56.9 | 24.5 |
| 195 | 290.2 | 117.2 | 5.1 | 2.5 | 56.7 | 22.9 |

^{a}Conditions for the CV/VP single gas permeation measurements: pre-evacuation at 35° C. followed by the introduction of an upstream pressure of 1520 Torr (2.03 bar) for each single gas measured. One barrer = 10⁻¹⁰ (cm³(STP) cm)/(cm² s cmHg).
^{b}Permeability ratio of the gas with the higher permeation relative to the gas with the lower.

TABLE 6
Comparison of permeabilities and selectivities resulting from the current work with the reported
polyimide (PI), commercially known as Matrimid, and MOF-PI mixed matrix membranes

| MOF | polymer | wt % | P(CO₂) | | CO₂/CH₄ | CO₂/N₂ | P(H₂) | | H₂/CO₂ | Year | ref |
|---|---|---|---|---|---|---|---|---|---|---|---|
| IRMOF-1 | PI | 20 | 38.8 | | 29.2 | | 33.1-114.9 | | 3.3-3.0 | 2009 | 4 |
| HKUST | PI | 30 | 22.1 | | 29.8 | | 66.9 | | 3.0 | 2009 | 4 |
| HKUST | PI | 30 | 10.0 | | 28 | | 33.1 | | 3.3 | 2009 | 4 |
| MOF-5 | PI | 10 | 9 | | 41.7 | 36 | 24.4 | | 2.7 | 2009 | 5 |
| MOF-5 | PI | 30 | 20.2 | | 44.7 | 38.8 | 53.8 | | 2.7 | 2009 | 5 |
| MOF-5 | PI | 30 | | | 38 | | | | 2.3 | 2009 | 5 |
| ZIF-8 | PI | 20 | 9.5 | | 39.7 | 30.6 | 28.9 | | 3.0 | 2010 | 6 |
| ZIF-8 | PI | 50 | 4.7 | | 124.9 | 26.2 | 18.1 | | 3.8 | 2010 | 6 |
| ZIF-90 | PI | 15 | 7.5 | | 34 | | | | | 2010 | 7 |
| ZIF-90 | PI | 15 | 10.5 | | 35 | | | | | 2010 | 7 |
| HKUST | PI | 10 | 10 | gpu | 18.5 | 18.0 | | | | 2011 | 8 |
| HKUST | PI | 30 | 17.5 | gpu | 23.0 | 23.5 | | | | 2011 | 8 |
| ZIF-8 | PI | 30 | 22.5 | gpu | 19.5 | 19.5 | | | | 2011 | 8 |
| ZIF-8 | PI | 10 | 10 | gpu | 18.5 | 18.0 | | | | 2011 | 8 |
| MIL-53 | PI | 10 | 10 | | 18.5 | 18 | | | | 2011 | 8 |
| ZIF-8 | PI | 25 | 23.2 | | 39 | | | | | 2012 | 9 |
| ZIF-8 | PI | 10 | 10.7 | | 34 | | | | | 2012 | 9 |
| ZIF-8 | PI | 5 | 8.1 | | 35.2 | 22.4 | 32.7 | | 4 | 2012 | 10 |
| ZIF-8 | PI | 20.30 | 16.6 | | 35.8 | 19 | 112.1 | | 3.9 | 2012 | 10 |
| ZIF-8 | PBI/PI | 10 | | | | | 89 | gpu | 9.5 | 2012 | 11 |
| ZIF-8 | PBI/PI | 10 | | | | | 2.1 | gpu | 6.2 | 2012 | 11 |
| ZIF-8 | PBI/PI | 10 | | | | | 65.4 | gpu | 12.3 | 2012 | 11 |
| NH2-MIL- | PI | 15 | 9.2 | | 2.1 | | | | | 2013 | 12 |
| 53(Al) | | | | | | | | | | | |
| NH2-MIL- | PI | 15 | 6.2 | | 31 | | | | | 2013 | 12 |
| 53(Al) | | | | | | | | | | | |
| MIL-53 | PI | 15 | 6.7 | | 9.4 | | | | | 2013 | 12 |
| MIL-53 | PI | 15 | 6.2 | | 31 | | | | | 2013 | 12 |
| MIL-53 | PI | 15 | | | 28.5 | | | | | 2013 | 12 |
| MIL-53 | PI | 15 | | | 8.5 | | | | | 2013 | 12 |

| TKL-107 | PI | 5 | 7 | 36 | | | | 2013 | 13 |
|---|---|---|---|---|---|---|---|---|---|
| TKL-107 | PI | 20 | 17 | 64.6 | | | | 2013 | 13 |
| MIL-53 | PI | 5 | 6.4 | 28.2 | | | | 2014 | 14 |
| MIL-53 | PI | 15 | 12.4 | 51.8 | | | | 2014 | 14 |
| NH2-MIL- | PI | 15 | 4.8 | 100 | | | | 2014 | 15 |
| 53(Al) | | | | | | | | | |
| NH2-MIL- | PI | 25 | 3.9 | 107 | | | | 2014 | 15 |
| 53(Al) | | | | | | | | | |
| NH2-MIL- | PSF/PI | 15 | 5.2 | 23 | | | | 2014 | 15 |
| 53(Al) | | | | | | | | | |
| NH2-MIL- | PSF/PI | 25 | 5.4 | 27.5 | | | | 2014 | 15 |
| 53(Al) | | | | | | | | | |
| ZIF-8 | PI | 15 | 26 | 35 | | | | 2014 | 16 |
| ZIF-8 | PI | 15 | 9 | 34.5 | | | | 2014 | 16 |
| ZIF-7-8-(20) | PI | 15 | 9 | 34.5 | | | | 2014 | 16 |
| ZIF-7-8-(20) | PI | 15 | 20 | 35.5 | | | | 2014 | 16 |
| ZIF-7-8-(20) | PI | 15 | 8 | 43 | | | | 2014 | 16 |
| ZIF-7-8-(20) | PI | 15 | 19 | 41 | | | | 2014 | 16 |
| ZIF-8-ambz- | PI | 15 | 12 | 36 | | | | 2014 | 16 |
| (15) | PI | 15 | 9 | 35.5 | | | | 2014 | 16 |
| ZIF-8-ambz- | | | | | | | | | |
| (15) | PI | 15 | 9 | 43 | | | | 2014 | 16 |
| ZIF-8-ambz- | | | | | | | | | |
| (15) | PI | 15 | 14 | 40 | | | | 2014 | 16 |
| ZIF-8-ambz- | | | | | | | | | |
| (15) | PI | 15 | 9 | 34.5 | | | | 2014 | 16 |
| ZIF-8-ambz- | | | | | | | | | |
| (30) | | | | | | | | | |
| ZIF-8-ambz- | PI | 15 | 11 | 38.5 | | | | 2014 | 16 |
| (30) | | | | | | | | | |
| ZIF-8-ambz- | PI | 15 | 8 | 43 | | | | 2014 | 16 |
| (30) | | | | | | | | | |
| ZIF-8-ambz- | PI | 15 | 11 | 42.5 | | | | 2014 | 16 |
| (30) | | | | | | | | | |
| FeBTC | PI | 10 | 14 | 55 | | | | 2014 | 17 |
| FeBTC | PI | 30 | 14 | 35 | | | | 2014 | 17 |
| FeBTC | PI | 10 | 14 | 22 | | | | 2014 | 17 |
| FeBTC | PI | 30 | 8.2 | 28 | | | | 2014 | 17 |
| MIL-53(Al)-ht | PI | 33.3 | 8.4 | 39.4 | 33.6 | 25.7 | 3.1 | 2014 | 18 |
| MlL-53(Al)-ht | PI | 37.5 | 51 | 47.0 | 28.3 | 103 | 2 | 2014 | 18 |
| MIL-53(al)-as | PI | 33.5 | 8.4 | 39.4 | 33.6 | 25.7 | 3.1 | 2014 | 18 |
| MIL-53(al)-as | PI | 37.5 | 51 | 47 | 28.3 | 103 | 2.0 | 2014 | 18 |
| MIL-53(al)-as | PI | 37.5 | 8.4 | 39.4 | 33.6 | 25.7 | 3.1 | 2014 | 18 |
| MIL-53(al)-as | pi | 37.5 | 40 | 90.1 | 95.2 | 66 | 1.7 | 2014 | 18 |
| HKUST-1 | PI | 20 | 7.6 | 37.5 | | | | | 18 |
| HKUST-1 | PI | 20 | 24.8 | 37.8 | | | | | 18 |
| MIL-53(Al) | PI | 10 | 14 | 55 | | | | 2014 | 19 |
| MIL-53(Al) | PI | 30 | 24 | 66 | | | | 2014 | 19 |
| ZIF-8 | PI | 10 | 14 | 55 | | | | 2014 | 19 |
| ZIF-8 | PI | 30 | 24 | 72 | | | | 2014 | 19 |
| HKUST-1 | PI | 10 | 14 | 55 | | | | 2014 | 19 |
| HKUST-1 | PI | 30 | 18 | 52 | | | | 2014 | 19 |
| MIL-53(Al) | PI | 10 | 9 | 5 | | | | 2014 | 19 |
| MIL-53(A1) | PI | 30 | 18 | 40 | | | | 2014 | 19 |
| ZIF-8 | PI | 10 | 9 | 5 | | | | 2014 | 19 |
| ZIF-8 | PI | 30 | 20 | 37 | | | | 2014 | 19 |
| HKUST-1 | PI | 10 | 9 | 5 | | | | 2014 | 19 |
| HKUST-1 | PI | 30 | 14 | 46 | | | | 2014 | 19 |
| b-Cu 1,4-BDC | PI- | 8 | 5.8 | 59.8 | | | | 2014 | 20 |
| Nc-Cu 1,4- | PI | 8 | 5.8 | 59.8 | | | | 2014 | 20 |
| BDC | | | | | | | | | |
| Nc-Cu 1,4- | PI | 8 | 5 | 49.4 | | | | 2014 | 20 |
| BDC | | | | | | | | | |
| Nc-Cu 2,6- | PI | 8 | 5.8 | 59.8 | | | | 2014 | 20 |
| NDC | | | | | | | | | |
| Nc-Cu 1,4- | PI | 2 | 5.9 | 47.7 | | | | 2014 | 20 |
| BDC | | | | | | | | | |
| Nc-Cu 1,4- | PI | 8 | 2.8 | 88.2 | | | | 2014 | 20 |
| BDC | | | | | | | | | |
| Nc-Cu 2,6- | PI | 8 | 6.3 | 43.5 | | | | 2014 | |
| NPC | | | | | | | | | |
| UIO-66 | PI | 20 | 25 | 40 | | | | 2015 | 21 |
| ZIF-8 | PI | 20 | 29 | 36 | | | | 2015 | 21 |
| Cu-BTC | PI | 20 | 33 | 37 | | | | 2015 | 21 |
| NH2-MIL-125 | PI | 10 | 500 | | | 4250 | 8 | 2016 | 22 |
| [Co4(μ4-O)(Me2pzba)3] | PI | 8 | 15.4 | 38 | | | | | 23 |
| [Co4(μ4-O)(Me2pzba)3] | PI | 16 | 18.5 | 41 | | | | | 23 |
| [Co4(μ4-O)(Me2pzba)3] | PI | 24 | 22.8 | 60 | | | | | 23 |
| ZIF-8 | PI | 50 | 13 | 124.9 | | | | | 24 |
| MOF-5 | PI | 30 | 20.2 | 44.7 | | | | | 5 |
| Cu-BPY-HFS | PI | 30 | 10.4 | 25.5 | | | | | 25 |
| MIL-53 | PI | 38 | 51.0 | 47 | | | | | 26 |

Refs [4]: Liu C, McCulloch B, Wilson S T, Benin A I, Schott M E. (2009). Metal organic framework-polymer mixed matrix membranes, U.S. Pat. No. 7,637,983B1; [5]: Perez, E. V., Balkus, K. J., Ferraris, J. P. & Musselman, I. H. Mixed-matrix membranes containing MOF-5 for gas separations. J. Membr. Sci. 328, 165-173 (2009); [6]: Ordoñez, M. J. C., Balkus, K. J., Ferraris, J. P. & Musselman, I. H. Molecular sieving realized with ZIF-8/Matrimid® mixed-matrix membranes. J. Membr. Sci. 361, 28-37 (2010); [7]: Bae, T.-H. et al. A High-Performance Gas-Separation Membrane Containing Submicrometer-Sized Metal-Organic Framework Crystals. Angew. Chem. Int. Ed. 49, 9863-9866 (2010); [8]: Basu, S., Cano-Odena, A. & Vankelecom, I. F. J. MOF-containing mixed-matrix membranes for CO₂/CH₄ and CO₂/N₂ binary gas mixture separations. Sep. Purif. Technol. 81, 31-40 (2011); [9]: Thompson, J. A., Chapman, K. W., Koros, W. J., Jones, C. W. & Nair, S. Sonication-induced Ostwald ripening of ZIF-8 nanoparticles and formation of ZIF-8/polymer composite membranes. Microporous Mesoporous Mater. 158, 292-299 (2012); [10]: Song, Q. et al. Zeolitic imidazolate framework (ZIF-8) based polymer nanocomposite membranes for gas separation. Energy Environ. Sci. 5, 8359-8369 (2012); [11]: Yang, T., Shi, G. M. & Chung, T.-S. Symmetric and Asymmetric Zeolitic Imidazolate Frameworks (ZIFs)/Polybenzimidazole (PBI) Nanocomposite Membranes for Hydrogen Purification at High Temperatures. Adv. Energy Mater. 2, 1358-1367 (2012); [12]: Chen, X. Y., Hoang, V.-T., Rodrigue, D. & Kaliaguine, S. Optimization of continuous phase in amino-functionalized metal-organic framework (MIL-53) based co-polyimide mixed matrix membranes for CO₂/CH₄ separation. RSC Adv. 3, 24266-24279 (2013); [13]: Zhang, D.-S. et al. Fluorous Metal-Organic Frameworks with Enhanced Stability and High H₂/CO₂ Storage Capacities. Sci. Rep. 3, 3312 (2013); [14]: Dorosti, F., Omidkhah, M. & Abedini, R. Fabrication and characterization of Matrimid/MIL-53 mixed matrix membrane for CO2/CH4 separation. Chem. Eng. Res. Des. 92,2439-2448 (2014); [15]: Rodenas, T., van Dalen, M., Serra-Crespo, P., Kapteijn, F. & Gascon, J. Mixed matrix membranes based on NH₂-functionalized MIL-type MOFs: Influence of structural and operational parameters on the CO₂/CH₄ separation performance. Microporous Mesoporous Mater. 192, 35-42 (2014); [16]: Thompson, J. A. et al. Mixed-linker zeolitic imidazolate framework mixed-matrix membranes for aggressive CO₂ separation from natural gas. Microporous Mesoporous Mater. 192, 43-51 (2014); [17]: Shahid, S. & Nijmeijer, K. High pressure gas separation performance of mixed-matrix polymer membranes containing mesoporous Fe(BTC). J. Membr. Sci. 459, 33-44 (2014); 1181: Hsieh, J. O., Balkus, K. J., Ferraris, J. P. & Musselman, I. H. MIL-53 frameworks in mixed-matrix membranes. Microporous Mesoporous Mater. 196, 165-174 (2014); 1191: Shahid, S. & Nijmeijer, K. Performance and plasticization behavior of polymer-MOF membranes for gas separation at elevated pressures. J. Membr. Sci. 470, 166-177 (2014); [20]: Rodenas, T. et al. Metal-organic framework nanosheets in polymer composite materials for gas separation. Nat. Mater. 14, 48 (2014); 1211: Kanehashi, S., Chen, G. Q., Ciddor, L., Chaffee, A. & Kentish, S. E. The impact of water vapor on CO2 separation performance of mixed matrix membranes. J. Membr. Sci. 492, 471-477 (2015); [22]: Friebe, S., Mundstock, A., Unmrh, D., Renz, F. & Caro, J. NH₂-MIL-125 as membrane for carbon dioxide sequestration: Thin supported MOF layers contra Mixed-Matrix-Membranes. J. Membr. Sci. 516, 185-193 (2016); [23]: Dechnik, J., Nuhnen, A. & Janiak, C. Mixed-Matrix Membranes of the Air-Stable MOF-5 Analogue [Co₄(μ4-O)(Me2pzba)₃] with a Mixed-Functional Pyrazolate-Carboxylate Linker for CO₂/CH₄ Separation. Cryst. Growth Des. 17, 4090-4099 (2017); [24]: Ordofiez, M. J. C., Balkus Jr, K. J., Ferraris, J. P. & Musselman, I. H. Molecular sieving realized with ZIF-8/Matrimid® mixed-matrix membranes. J. Membr. Sci. 361, 28-37 (2010); [25]: Zhang, Y., Balkus, K J., Musselman, I. H. & Ferraris, J. P. Mixed-matrix membranes composed of Matrimid® and mesoporous ZSM-5 nanoparticles. J. Membr. Sci. 325, 28-39 (2008); and [26]: Hsieh, J. O., Balkus, K J., Jr., Ferraris, J. P. & Musselman, I. H. MIL-53 frameworks in mixed-matrix membranes. Microporous Mesoporous Mater. 196, 165-174 (2014), each incorporated herein by reference in their entirety.

TABLE 7
Comparison of this work results with the reported
hydrogen separation on PI membranes

| Polymer | PCO₂ | CO₂/CH₄ | Year | Ref. |
|---|---|---|---|---|
| PI | 8.7 | 41 | | 23 |
| PI | 9 | 42 | | 27 |
| PI | 10 | 28 | | 28 |
| PI | 9 | 34 | | 29 |
| PI | 6 | 30 | | 30 |
| PI | 6 | 31 | | 31 |

Refs [23]: Dechnik, J., Nuhnen, A. & Janiak, C. Mixed-Matrix Membranes of the Air-Stable MOF-5 Analogue [Co₄(μ4-O)(Me2pzba)₃] with a Mixed-Functional Pyrazolate-Carboxylate Linker for CO₂/CH₄ Separation. Cryst. Growth Des. 17, 4090-4099 (2017); [27]: Perez, E., Balkus Jr, K., Ferraris, J. & Musselman, I. Mixed-matrix membranes containing MOF-5 for gas separations. J. Membr. Sci. 328, 165-173 (2009); [28]: Liu, C., Lesch, D. A. & Wilson, S. T. 12 pp., Chemical Indexing Equivalent to 150:542717 (WO) (UOP LLC, USA. 2009); [29]: Rodenas, T., van Dalen, M., Serra-Crespo, P., Kapteijn, F. & Gascon, J. Mixed matrix membranes based on NH2-functionalized MIL-type MOFs: Influence of structural and operational parameters on the CO₂/CH₄ separation performance. Microporous Mesoporous Mater. 192, 35-42 (2014); [30]: Anjum, M. W., Bueken, B., De Vos, D. & Vankelecom, I. F. MIL-125 (Ti) based mixed matrix membranes for CO₂ separation from CH₄ and N₂. J. Membr. Sci. 502, 21-28 (2016); and [31]: Anjum, M. W. et al. Modulated UiO-66-Based Mixed-Matrix Membranes for CO2 Separation. ACS Appl. Mater. Interfaces 7, 25193-25201 (2015), each incorporated herein by reference in their entirety.

TABLE 8
Comparison of this work results with the reported hydrogen
separation on MOF-based mixed matrix membranes

| MOF | Polymer | Wt % | P(CO₂) | CO₂/CH₄ | CO₂/N₂ | P(H₂) | H₂/CO₂ | Year | Ref |
|---|---|---|---|---|---|---|---|---|---|
| 2014 | | 10 | 2500 | 3.1 | 7 | 550 | 0.2 | 2006 | 32 |
| | | 40 | 2900 | 3.6 | 8.9 | 900 | 0.4 | 2006 | 32 |
| | psf | 5 | 6.5 | 18 | 20 | 9.8 | 1.5 | 2006 | 32 |
| | | 10 | 7.5 | 21.5 | 25 | 15 | 1.9 | 2006 | 32 |
| IRMOF-1 | Ultem | 10 | 2 | 30.3 | | 11.2 | 5.7 | 2009 | 4 |
| | | 20 | 3 | 26.3 | | 16.9 | 5.7 | 2009 | 4 |
| ZIF-7 | PBI | 10 | | | | 3.7 | 8.7 | | 33 |
| | | 50 | | | | 26.2 | 14.9 | | 33 |
| ZIF-8 | PPEEs | 10 | 5.4 | 22.9 | 30.1 | 6.7 | 1.3 | | 34 |
| | | 30 | 50 | 20.8 | 24.5 | 92.3 | 1.8 | | 34 |
| MIL-53(Al) | PMDA- | 5 | 0.3 | 72.1 | 34.8 | 35 | 1.1 | | 35 |
| | ODA | | | | | | | | |
| ZIF-8 | | 10 | | | | 3.7 | 8.6 | | 11 |
| | | 29 | | | | 105.4 | 12.3 | | 11 |
| ZIF-8 | PBI | 30 | | | | 4.1 | 8.9 | | 36 |
| ZIF-8 | PIM-1 | 11 | 4815 | 15 | 19.3 | 2560 | 0.5 | | 37 |
| | | 28 | 4270 | 18.6 | 21.9 | 2980 | 0.7 | | 37 |
| | | 36 | 6820 | 13.4 | 17.9 | 5745 | 0.8 | | 37 |
| | | 43 | 6300 | 14.7 | 18.0 | 6680 | 1.1 | | 37 |
| ZIF-90 | PBI | 10 | | | | 4.1 | 8.9 | | 38 |
| HKUST-1 | PPO | 10 | 68.7 | 16.4 | 16 | 75 | 1.1 | | 39 |
| ZIF-8 | 6FDA- | 33.3 | 486.5 | 15.6 | 13.4 | 518.5 | 1.1 | | 40 |
| | durene | | | | | | | | |
| NH2-MIL- | 15 | 66.5 | 36.9 | | | 90.1 | 1.6 | | 41 |
| 125(Al) | | | | | | | | | |
| | 10 | 134 | 30.2 | | | 169 | 1.3 | | 41 |
| ZIF-8 | PBI-Bul | 10 | 2.3 | 57 | 26.8 | 6.2 | 2.7 | | 42 |
| | | 30 | 5.2 | 43.6 | 16 | 22.1 | 4.2 | | 42 |
| | DMPBI- | 10 | 3.8 | 47.2 | 21.7 | 12.8 | 3.4 | | 42 |
| | Bul | | | | | | | | |
| | | 30 | 53.9 | 15.7 | 11.3 | 127.5 | 2.4 | | 42 |
| | DBzPBI- | 10 | 25.8 | 15.9 | 12.9 | 61.4 | 2.4 | | 42 |
| | Bul | | | | | | | | |
| | | 20 | 89.8 | 11.6 | 14.3 | 180.3 | 2 | | 42 |
| c-MOF-5 | PEI | 25 | 5.4 | 23.4 | 28.4 | 28.3 | 5.3 | | 43 |
| ZIF-71 | 6FDA- | 10 | 1805 | 16.1 | 14.9 | 1563 | 0.87 | | 44 |
| | durene | | | | | | | | |
| | | 20 | 4006 | 12.8 | 12.9 | 2310 | 0.58 | | 44 |
| | | 30 | 7750 | 9.53 | 11.5 | 4533 | 0.59 | | 44 |

Refs [4]: Liu C, McCulloch B, Wilson S T, Benin A I, Schott M E. (2009). Metal organic framework-polymer mixed matrix membranes, U.S. Pat. No. 7,637,983B1; [11]: Yang, T., Shi, G. M. & Chung, T.-S. Symmetric and Asymmetric Zeolitic Imidazolate Frameworks (ZIFs)/Polybenzimidazole (PBI) Nanocomposite Membranes for Hydrogen Purification at High Temperatures. Adv. Energy Mater. 2, 1358-1367 (2012); [32]: Car, A., Stropnik, C. & Peinemann, K.-V. Hybrid membrane materials with different metal-organic frameworks (MOFs) for gas separation. Desalination 200, 424-426 (2006); [33]: Yang, T., Xiao, Y. & Chung, T.-S. Poly-/metal-benzimidazole nano-composite membranes for hydrogen purification. Energy Environ. Sci. 4, 4171-4180 (2011); [34]: Dfaz, K., López-Gonález, M., del Castillo, L. F. & Riande, E. Effect of zeolitic imidazolate frameworks on the gas transport performance of ZIF8-poly(1,4-phenylene ether-ether-sulfone) hybrid membranes. J. Membr. Sci. 383, 206-213 (2011); [35]: Ren, H., Jin, J., Hu, J. & Liu, H. Affinity between Metal-Organic Frameworks and Polyimides in Asymmetric Mixed Matrix Membranes for Gas Separations. Ind. Eng. Chem. Res. 51, 10156-10164 (2012); [36]: Yang, T. & Chung, T.-S. High performance ZIF-8/PBI nano-composite membranes for high temperature hydrogen separation consisting of carbon monoxide and water vapor. Int. J. Hydrog. Energy 38, 229-239 (2013); [37]: Bushell, A. F. et al. Gas permeation parameters of mixed matrix membranes based on the polymer of intrinsic microporosity PIM-1 and the zeolitic imidazolate framework ZIF-8. J. Membr. Sci. 427, 48-62 (2013); [38]: Yang, T. & Chung, T.-S. Room-temperature synthesis of ZIF-90 nanocrystals and the derived nano-composite membranes for hydrogen separation. J. Mater. Chem. A 1, 6081-6090 (2013); [39]: Ge, L., Zhou, W., Rudolph, V. & Zhu, Z. Mixed matrix membranes incorporated with size-reduced Cu-BTC for improved gas separation. J. Mater. Chem. A 1, 6350-6358 (2013); 1401: Wijenayake, S. N. et al. Surface Cross-Linking of ZIF-8/Polyimide Mixed Matrix Membranes (MMMs) for Gas Separation. Ind. Eng. Chem. Res. 52, 6991-7001 (2013); (411: Seoane, B., Sebastian, V., Tellez, C. & Coronas, J. Crystallization in THF: the possibility of one-pot synthesis of mixed matrix membranes containing MOF MIL-68(Ai). CrystEngComm 15, 9483-9490 (2013); [42]: Bhaskar, A., Banerjee, R. & Kharul, U. ZIF-8®PBI-BuI composite membranes: elegant effects of PBI structural variations on gas permeation performance. J. Mater. Chem. A 2, 12962-12967 (2014); [43]: Arjmandi, M. & Pakizeh, M. Mixed matrix membranes incorporated with cubic-MOF-5 for improved polyetherimide gas separation membranes: Theory and experiment. Ind. Eng. Chem. Res. 20, 3857-3868 (2014); and [44]: Japip, S., Wang, H., Xiao, Y. & Shung Chung, T. Highly permeable zeolitic imidazolate framework (ZIF)-71 nano-particles enhanced polyimide membranes for gas separation. J. Membr. Sci. 467, 162-174 (2014), each incorporated herein by reference in their entirety.

### Example 8

### The Membrane Described Herein is the First ZIF-302/PI Self-Consistent Spongy Polyimide Membrane.

The fabricated membrane with a unique spongy texture possesses highly uniform and dis-interconnected pores that lower the membrane density with a minimal effect on selectivity. The analysis of the gas transport mechanisms on the dense, and the spongy membranes, in addition to their relevant ZIF-302 Mixed Matrix Membranes (MMMs) showed the development of dominant diffusion driven permselectivity on the spongy membranes compared to the dense membranes. The successful adaptation of the self-consistent spongy texture caused a remarkable improvement of the H₂/CO₂, H₂/CH₄, CO₂/N₂ and CO₂/CH₄ separations with an exceptional H₂/N₂ permselectivity that surpassed the upper bound curve in some cases. These results prove ZIF-302/s-PI a promising candidate for the practical implementations. Additionally, the clear cut-off of permeability for gases larger than O₂ (3.46 Å), compared to smaller gases, make the membrane an exceptional candidate for the separation of smaller gases (e.g., H₂ and CO₂) from larger gas molecules and hydrocarbons. Finally, it is demonstrated that self-consistent spongy membrane as a possible solution to many existing membranes which are highly selective, but weakly permeable.

1: A membrane, comprising:
a polymer matrix; and
a metal-organic framework filler comprising a ligand coordinated to a metal ion, wherein the ligand comprises an imidazole of formula (I) and a benzimidazole of formula (II): 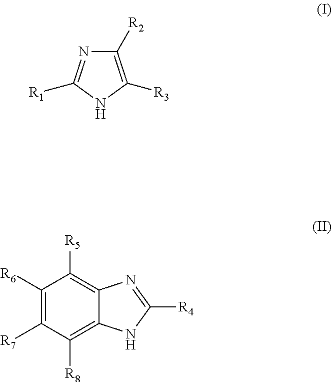
wherein:
R₁, R₂, R₃, R₄, R₅, R₆, R₇, and R₈ are each independently selected from the group consisting of a hydrogen, an optionally substituted alkyl, an optionally substituted cycloalkyl, an optionally substituted alkoxy, a hydroxyl, a halogen, a nitro, and a cyano; and
the metal ion is an ion of at least one metal selected from the group consisting of a transition metal, a post-transition metal, and an alkaline earth metal;
wherein:
the metal-organic framework filler is embedded in the polymer matrix at an amount of 1 wt %-50 wt % relative to a total weight of the membrane; and
the membrane has pores and a spongy morphology.

2: The membrane of claim 1, wherein the pores have an average diameter in a range of 0.5-10 μm.

3: The membrane of claim 1, wherein the pores are monolithic and substantially parallel to each other.

4: The membrane of claim 1, wherein the polymer matrix comprises at least one selected from the group consisting of a polyimide, a polyamide, a polyamide-imide, a polyetherimide, and a polyether ether ketone.

5: The membrane of claim 4, wherein the polymer matrix comprises the polyimide.

6: The membrane of claim 1, wherein the imidazole of formula (I) is 2-methylimidazole.

7: The membrane of claim 1, wherein the benzimidazole of formula (II) is 5-methylbenzimidazole.

8: The membrane of claim 1, wherein a molar ratio between the imidazole of formula (I) to the benzimidazole of formula (II) ranges from 1:1 to 1:4.

9: The membrane of claim 1, wherein the metal ion is an ion of at least one metal selected from the group consisting of Zn, Cu, Fe, Ni, Co, Mn, Cr, Cd, Mg, Ca, and Zr.

10: The membrane of claim 1, wherein the metal-organic framework filler comprises ZIF-302.

11: The membrane of claim 1, which comprises 1-10 wt % of the metal-organic framework filler relative to a total weight of the membrane.

12: The membrane of claim 1, wherein the metal-organic framework filler is in the form of block-shaped particles with an average particle size of 0.5-5 μm.

13: The membrane of claim 1, wherein the metal-organic framework filler has a BET surface area in a range of 350-450 m²/g.

14: The membrane of claim 1, which has an ideal selectivity of hydrogen over a gas selected from the group consisting of oxygen, nitrogen, carbon dioxide and methane in a range of 2-70, and an ideal selectivity of carbon dioxide over a gas selected from the group consisting of nitrogen and methane in a range of 15-35.

15: A method of producing the membrane of claim 5, the method comprising:
suspending the metal-organic framework filler in a first solvent to form a suspension;
dissolving the polyimide in a second solvent to form a solution;
mixing the suspension with the solution to form a mixture;
casting the mixture to form a membrane blend;
coagulating the membrane blend at a temperature of 20-90° C. for 18-36 hours to form a coagulated membrane; and
drying the coagulated membrane at a temperature of 150-250° C. for 6-24 hours thereby forming the membrane;
wherein a weight ratio of the metal-organic framework filler to the polyimide is in a range of 1:99 to 1:1.

16: The method of claim 15, wherein the first solvent is dimethylacetamide.

17: The method of claim 15, wherein the second solvent comprises dimethylacetamide and dimethylformamide.

18: The method of claim 15, wherein the suspension is mixed with the solution for a period of 6-24 hours at 30-60° C. under reduced pressure.

19: A method of recovering a first gas from a gas mixture comprising the first gas and a second gas, the method comprising:
delivering the gas mixture into a feed side of a chamber comprising the membrane of claim 1 that divides the chamber into the feed side and a permeate side, such that at least a portion of the first gas permeates the membrane; and
recovering from the permeate side a stream enriched in the first gas compared to the gas mixture.

20: The method of claim 19, wherein the first gas is hydrogen, carbon dioxide, or both, and the second gas is at least one selected from the group consisting of oxygen, nitrogen, and methane.
